(19) United States
(12) Patent Application Publication
(10) Pub. No.: US 2025/0076651 A1
(43) Pub. Date: Mar. 6, 2025

(54) NANOPATTERN ENCAPSULATION FUNCTION, METHOD AND PROCESS IN COMBINED OPTICAL COMPONENTS

(71) Applicant: Magic Leap, Inc., Plantation, FL (US)

(72) Inventors: Vikramjit SINGH, Pflugerville, TX (US); Michael Nevin MILLER, Austin, TX (US); T.G. ANDERSON, Plantation, FL (US); Frank Y. XU, Austin, TX (US)

(21) Appl. No.: 18/554,613

(22) PCT Filed: Apr. 13, 2022
(86) PCT No.: PCT/US2022/071696

§ 371 Date: Oct. 9, 2023

Related U.S. Application Data
(60) Provisional application No. 63/176,077, filed on Apr. 16, 2021.

(51) Int. Cl. G02B 27/01; B82Y 20/00; G02B 27/00

(52) U.S. Cl. CPC G02B 27/0172; B82Y 20/00; G02B 27/0093; G02B 2027/0174; G02B 2027/0178

(57) ABSTRACT

Disclosed herein are systems and methods for displays, such as for a head wearable device. An example display can include an infrared illumination layer, the infrared illumination layer including a substrate, one or more LEDs disposed on a first surface of the substrate, and a first encapsulation layer disposed on the first surface of the substrate, where the encapsulation layer can include a nano-patterned surface. In some examples, the nano-patterned surface can be configured to improve a visible light transmittance of the illumination layer. In one or more examples, embodiments disclosed herein may provide a robust illumination layer that can reduce the haze associated with an illumination layer.

### CROSS-REFERENCE TO RELATED APPLICATIONS

This application claims priority to U.S. Provisional Application No. 63/176,077, filed on Apr. 16, 2021, the contents of which are incorporated by reference herein in its entirety.

### FIELD

This disclosure relates in general to systems for displaying visual information, and in particular to eyepieces for displaying visual information and/or performing eye-tracking in an augmented reality or mixed reality environment.

### BACKGROUND

Virtual environments are ubiquitous in computing environments, finding use in video games (in which a virtual environment may represent a game world); maps (in which a virtual environment may represent terrain to be navigated); simulations (in which a virtual environment may simulate a real environment); digital storytelling (in which virtual characters may interact with each other in a virtual environment); and many other applications. Modern computer users are generally comfortable perceiving, and interacting with, virtual environments. However, users' experiences with virtual environments can be limited by the technology for presenting virtual environments. For example, conventional displays (e.g., 2D display screens) and audio systems (e.g., fixed speakers) may be unable to realize a virtual environment in ways that create a compelling, realistic, and immersive experience.

Virtual reality (“VR”), augmented reality (“AR”), mixed reality (“MR”), and related technologies (collectively, “XR”) share an ability to present, to a user of an XR system, sensory information corresponding to a virtual environment represented by data in a computer system. This disclosure contemplates a distinction between VR, AR, and MR systems (although some systems may be categorized as VR in one aspect (e.g., a visual aspect), and simultaneously categorized as AR or MR in another aspect (e.g., an audio aspect)). As used herein, VR systems present a virtual environment that replaces a user's real environment in at least one aspect; for example, a VR system could present the user with a view of the virtual environment while simultaneously obscuring his or her view of the real environment, such as with a light-blocking head-mounted display. Similarly, a VR system could present the user with audio corresponding to the virtual environment, while simultaneously blocking (attenuating) audio from the real environment.

VR systems may experience various drawbacks that result from replacing a user's real environment with a virtual environment. One drawback is a feeling of motion sickness that can arise when a user's field of view in a virtual environment no longer corresponds to the state of his or her inner ear, which detects one's balance and orientation in the real environment (not a virtual environment). Similarly, users may experience disorientation in VR environments where their own bodies and limbs (views of which users rely on to feel “grounded” in the real environment) are not directly visible. Another drawback is the computational burden (e.g., storage, processing power) placed on VR systems, which must present a full 3D virtual environment, particularly in real-time applications that seek to immerse the user in the virtual environment. Similarly, such environments may need to reach a very high standard of realism to be considered immersive, as users tend to be sensitive to even minor imperfections in virtual environments-any of which can destroy a user's sense of immersion in the virtual environment. Further, another drawback of VR systems is that such applications of systems cannot take advantage of the wide range of sensory data in the real environment, such as the various sights and sounds that one experiences in the real world. A related drawback is that VR systems may struggle to create shared environments in which multiple users can interact, as users that share a physical space in the real environment may not be able to directly see or interact with each other in a virtual environment.

As used herein, AR systems present a virtual environment that overlaps or overlays the real environment in at least one aspect. For example, an AR system could present the user with a view of a virtual environment overlaid on the user's view of the real environment, such as with a transmissive head-mounted display that presents a displayed image while allowing light to pass through the display into the user's eye. Similarly, an AR system could present the user with audio corresponding to the virtual environment, while simultaneously mixing in audio from the real environment. Similarly, as used herein, MR systems present a virtual environment that overlaps or overlays the real environment in at least one aspect, as do AR systems, and may additionally allow that a virtual environment in an MR system may interact with the real environment in at least one aspect. For example, a virtual character in a virtual environment may toggle a light switch in the real environment, causing a corresponding light bulb in the real environment to turn on or off. As another example, the virtual character may react (such as with a facial expression) to audio signals in the real environment. By maintaining presentation of the real environment, AR and MR systems may avoid some of the aforementioned drawbacks of VR systems; for instance, motion sickness in users is reduced because visual cues from the real environment (including users' own bodies) can remain visible, and such systems need not present a user with a fully realized 3D environment in order to be immersive. Further, AR and MR systems can take advantage of real world sensory input (e.g., views and sounds of scenery, objects, and other users) to create new applications that augment that input.

Presenting a virtual environment in a realistic manner to create an immersive experience for the user in a robust and cost effective manner can be difficult. For example, a head mounted display can include an optical system having one or more multi-layered eyepieces. The eyepiece can be an expensive and fragile component that includes multiple layers that perform different functions. For example, one or more layers may be used to display virtual content to the user and one or more layers may be used as an infrared (IR) illumination layer for eye-tracking. The multiple layers may result in a bulky eyepiece that adds weight to a MR system. Additionally, light transmission loss due to reflection and haze on the surface of the layers can affect the quality of the virtual content. Moreover, the layers, e.g., IR illumination layer that include electronic components such as LEDs and metal interconnects may be susceptible to corrosion and/or oxidation. Thus, it is desirable to improve the transmittance of the eyepiece, prevent corrosion of electronic components and leads, and to do so in a lightweight and compact form factor.

### BRIEF SUMMARY

Disclosed herein are systems and methods for displays, such as for a head wearable device. An example display can include an infrared illumination layer, the infrared illumination layer including a substrate, one or more LEDs disposed on a first surface of the substrate, and a first encapsulation layer disposed on the first surface of the substrate, where the encapsulation layer can include a nano-patterned surface. In some examples, the nano-patterned surface can be configured to improve a visible light transmittance of the illumination layer. Embodiments disclosed herein may provide a robust illumination layer that can reduce the haze associated with an illumination layer. Moreover, embodiments disclosed herein can prevent corrosion of electronic components and/or lead lines. Further, embodiments disclosed herein may provide for a smaller display having a reduced number of optical components and optical interfaces, which can improve the optical image quality presented to a user.

### BRIEF DESCRIPTION OF THE DRAWINGS

FIGS. 1A-1C illustrate an example mixed reality environment, according to one or more embodiments of the disclosure.

FIGS. 2A-2D illustrate components of an example mixed reality system that can be used to generate and interact with a mixed reality environment, according to one or more embodiments of the disclosure.

FIG. 3A illustrates an example mixed reality handheld controller that can be used to provide input to a mixed reality environment, according to one or more embodiments of the disclosure.

FIG. 3B illustrates an example auxiliary unit that can be used with an example mixed reality system, according to one or more embodiments of the disclosure.

FIG. 4 illustrates an example functional block diagram for an example mixed reality system, according to one or more embodiments of the disclosure.

FIG. 5 illustrates an example optical system for an example mixed reality system, according to one or more embodiments of the disclosure.

FIGS. 6A-6B illustrate examples of illumination layers for an example mixed reality system, according to one or more embodiments of the disclosure.

FIGS. 7A-7D illustrate examples of illumination layers for an example mixed reality system, according to one or more embodiments of the disclosure.

FIGS. 8A-8D illustrate examples of illumination layers for an example mixed reality system, according to one or more embodiments of the disclosure.

FIG. 9 illustrates a graph of exemplary transmittance for illumination layers for an example mixed reality system, according to one or more embodiments of the disclosure.

FIG. 10 illustrates examples of illumination layers for an example mixed reality system, according to one or more embodiments of the disclosure.

FIG. 11 illustrates an example of an illumination layer for an example mixed reality system, according to one or more embodiments of the disclosure.

FIG. 12 illustrates an example of an illumination layer for an example mixed reality system, according to one or more embodiments of the disclosure.

FIG. 13 illustrates an example of an illumination layer for an example mixed reality system, according to one or more embodiments of the disclosure.

FIG. 14 illustrates an example of an illumination layer for an example mixed reality system, according to one or more embodiments of the disclosure.

FIG. 15 illustrates an example of an illumination layer for an example mixed reality system, according to one or more embodiments of the disclosure.

FIG. 16 illustrates an example of an illumination layer for an example mixed reality system, according to one or more embodiments of the disclosure.

FIGS. 17A-17E illustrate examples of nano-patterns for an illumination layer for an example mixed reality system, according to one or more embodiments of the disclosure.

FIG. 17F is a graph illustrating exemplary transmittance for illumination layers for an example mixed reality system, according to one or more embodiments of the disclosure.

FIG. 18 illustrates a process for manufacturing illumination layers for an example mixed reality system, according to one or more embodiments of the disclosure.

FIG. 19 illustrates a block diagram of a process for manufacturing illumination layers for an example mixed reality system, according to one or more embodiments of the disclosure.

FIGS. 20A-20B illustrate examples of an illumination layer for an example mixed reality system, according to one or more embodiments of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

### Mixed Reality Environment

Like all people, a user of a mixed reality system exists in a real environment—that is, a three-dimensional portion of the “real world,” and all of its contents, that are perceptible by the user. For example, a user perceives a real environment using one's ordinary human senses-sight, sound, touch, taste, smell—and interacts with the real environment by moving one's own body in the real environment. Locations in a real environment can be described as coordinates in a coordinate space; for example, a coordinate can comprise latitude, longitude, and elevation with respect to sea level; distances in three orthogonal dimensions from a reference point; or other suitable values. Likewise, a vector can describe a quantity having a direction and a magnitude in the coordinate space.

A computing device can maintain, for example in a memory associated with the device, a representation of a virtual environment. As used herein, a virtual environment is a computational representation of a three-dimensional space. A virtual environment can include representations of any object, action, signal, parameter, coordinate, vector, or other characteristic associated with that space. In some examples, circuitry (e.g., a processor) of a computing device can maintain and update a state of a virtual environment; that is, a processor can determine at a first time 10, based on data associated with the virtual environment and/or input provided by a user, a state of the virtual environment at a second time t1. For instance, if an object in the virtual environment is located at a first coordinate at time t0, and has certain programmed physical parameters (e.g., mass, coefficient of friction); and an input received from user indicates that a force should be applied to the object in a direction vector; the processor can apply laws of kinematics to determine a location of the object at time t1 using basic mechanics. The processor can use any suitable information known about the virtual environment, and/or any suitable input, to determine a state of the virtual environment at a time t1. In maintaining and updating a state of a virtual environment, the processor can execute any suitable software, including software relating to the creation and deletion of virtual objects in the virtual environment; software (e.g., scripts) for defining behavior of virtual objects or characters in the virtual environment; software for defining the behavior of signals (e.g., audio signals) in the virtual environment; software for creating and updating parameters associated with the virtual environment; software for generating audio signals in the virtual environment; software for handling input and output; software for implementing network operations; software for applying asset data (e.g., animation data to move a virtual object over time); or many other possibilities.

Output devices, such as a display or a speaker, can present any or all aspects of a virtual environment to a user. For example, a virtual environment may include virtual objects (which may include representations of inanimate objects; people; animals; lights; etc.) that may be presented to a user. A processor can determine a view of the virtual environment (for example, corresponding to a “camera” with an origin coordinate, a view axis, and a frustum); and render, to a display, a viewable scene of the virtual environment corresponding to that view. Any suitable rendering technology may be used for this purpose. In some examples, the viewable scene may include only some virtual objects in the virtual environment, and exclude certain other virtual objects. Similarly, a virtual environment may include audio aspects that may be presented to a user as one or more audio signals. For instance, a virtual object in the virtual environment may generate a sound originating from a location coordinate of the object (e.g., a virtual character may speak or cause a sound effect); or the virtual environment may be associated with musical cues or ambient sounds that may or may not be associated with a particular location. A processor can determine an audio signal corresponding to a “listener” coordinate—for instance, an audio signal corresponding to a composite of sounds in the virtual environment, and mixed and processed to simulate an audio signal that would be heard by a listener at the listener coordinate—and present the audio signal to a user via one or more speakers.

Because a virtual environment exists only as a computational structure, a user cannot directly perceive a virtual environment using one's ordinary senses. Instead, a user can perceive a virtual environment only indirectly, as presented to the user, for example by a display, speakers, haptic output devices, etc. Similarly, a user cannot directly touch, manipulate, or otherwise interact with a virtual environment; but can provide input data, via input devices or sensors, to a processor that can use the device or sensor data to update the virtual environment. For example, a camera sensor can provide optical data indicating that a user is trying to move an object in a virtual environment, and a processor can use that data to cause the object to respond accordingly in the virtual environment.

A mixed reality system can present to the user, for example using a transmissive display and/or one or more speakers (which may, for example, be incorporated into a wearable head device), a mixed reality environment (“MRE”) that combines aspects of a real environment and a virtual environment. In some embodiments, the one or more speakers may be external to the head-mounted wearable unit. As used herein, a MRE is a simultaneous representation of a real environment and a corresponding virtual environment. In some examples, the corresponding real and virtual environments share a single coordinate space; in some examples, a real coordinate space and a corresponding virtual coordinate space are related to each other by a transformation matrix (or other suitable representation). Accordingly, a single coordinate (along with, in some examples, a transformation matrix) can define a first location in the real environment, and also a second, corresponding, location in the virtual environment; and vice versa.

In a MRE, a virtual object (e.g., in a virtual environment associated with the MRE) can correspond to a real object (e.g., in a real environment associated with the MRE). For instance, if the real environment of a MRE comprises a real lamp post (a real object) at a location coordinate, the virtual environment of the MRE may comprise a virtual lamp post (a virtual object) at a corresponding location coordinate. As used herein, the real object in combination with its corresponding virtual object together constitute a “mixed reality object.” It is not necessary for a virtual object to perfectly match or align with a corresponding real object. In some examples, a virtual object can be a simplified version of a corresponding real object. For instance, if a real environment includes a real lamp post, a corresponding virtual object may comprise a cylinder of roughly the same height and radius as the real lamp post (reflecting that lamp posts may be roughly cylindrical in shape). Simplifying virtual objects in this manner can allow computational efficiencies, and can simplify calculations to be performed on such virtual objects. Further, in some examples of a MRE, not all real objects in a real environment may be associated with a corresponding virtual object. Likewise, in some examples of a MRE, not all virtual objects in a virtual environment may be associated with a corresponding real object. That is, some virtual objects may solely in a virtual environment of a MRE, without any real-world counterpart.

In some examples, virtual objects may have characteristics that differ, sometimes drastically, from those of corresponding real objects. For instance, while a real environment in a MRE may comprise a green, two-armed cactus—a prickly inanimate object—a corresponding virtual object in the MRE may have the characteristics of a green, two-armed virtual character with human facial features and a surly demeanor. In this example, the virtual object resembles its corresponding real object in certain characteristics (color, number of arms); but differs from the real object in other characteristics (facial features, personality). In this way, virtual objects have the potential to represent real objects in a creative, abstract, exaggerated, or fanciful manner; or to impart behaviors (e.g., human personalities) to otherwise inanimate real objects. In some examples, virtual objects may be purely fanciful creations with no real-world counterpart (e.g., a virtual monster in a virtual environment, perhaps at a location corresponding to an empty space in a real environment).

Compared to VR systems, which present the user with a virtual environment while obscuring the real environment, a mixed reality system presenting a MRE affords the advantage that the real environment remains perceptible while the virtual environment is presented. Accordingly, the user of the mixed reality system is able to use visual and audio cues associated with the real environment to experience and interact with the corresponding virtual environment. As an example, while a user of VR systems may struggle to perceive or interact with a virtual object displayed in a virtual environment—because, as noted above, a user cannot directly perceive or interact with a virtual environment—a user of an MR system may find it intuitive and natural to interact with a virtual object by seeing, hearing, and touching a corresponding real object in his or her own real environment. This level of interactivity can heighten a user's feelings of immersion, connection, and engagement with a virtual environment. Similarly, by simultaneously presenting a real environment and a virtual environment, mixed reality systems can reduce negative psychological feelings (e.g., cognitive dissonance) and negative physical feelings (e.g., motion sickness) associated with VR systems. Mixed reality systems further offer many possibilities for applications that may augment or alter our experiences of the real world.

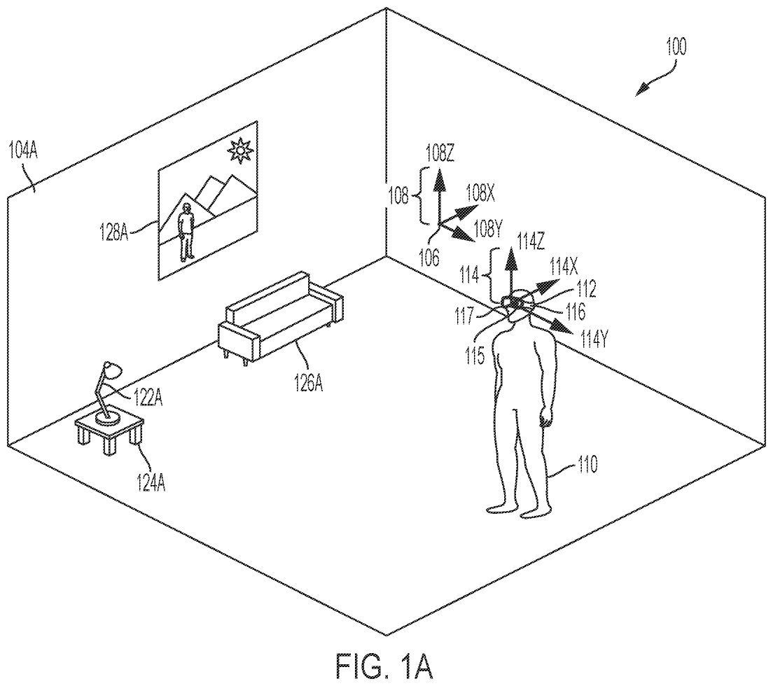

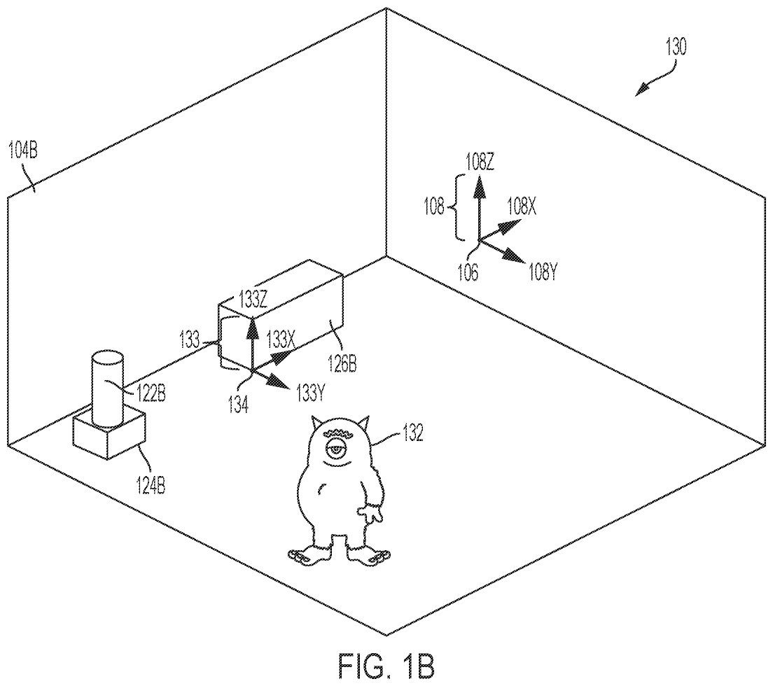

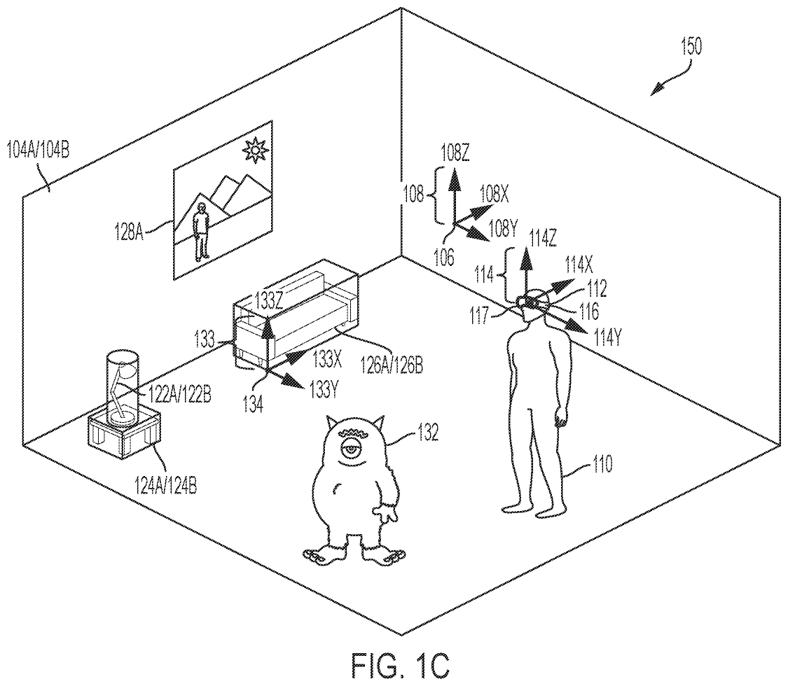

FIG. 1A illustrates an example real environment 100 in which a user 110 uses a mixed reality system 112. Mixed reality system 112 may comprise a display (e.g., a transmissive display) and one or more speakers, and one or more sensors (e.g., a camera), for example as described below. The real environment 100 shown comprises a rectangular room 104A, in which user 110 is standing; and real objects 122A (a lamp), 124A (a table), 126A (a sofa), and 128A (a painting). Room 104A further comprises a location coordinate 106, which may be considered an origin of the real environment 100. As shown in FIG. 1A, an environment/world coordinate system 108 (comprising an x-axis 108X, a y-axis 108Y, and a z-axis 108Z) with its origin at point 106 (a world coordinate), can define a coordinate space for real environment 100. In some embodiments, the origin point 106 of the environment/world coordinate system 108 may correspond to where the mixed reality system 112 was powered on. In some embodiments, the origin point 106 of the environment/world coordinate system 108 may be reset during operation. In some examples, user 110 may be considered a real object in real environment 100; similarly, user 110's body parts (e.g., hands, feet) may be considered real objects in real environment 100. In some examples, a user/listener/head coordinate system 114 (comprising an x-axis 114X, a y-axis 114Y, and a z-axis 114Z) with its origin at point 115 (e.g., user/listener/head coordinate) can define a coordinate space for the user/listener/head on which the mixed reality system 112 is located. The origin point 115 of the user/listener/head coordinate system 114 may be defined relative to one or more components of the mixed reality system 112. For example, the origin point 115 of the user/listener/head coordinate system 114 may be defined relative to the display of the mixed reality system 112 such as during initial calibration of the mixed reality system 112. A matrix (which may include a translation matrix and a Quaternion matrix or other rotation matrix), or other suitable representation can characterize a transformation between the user/listener/head coordinate system 114 space and the environment/world coordinate system 108 space. In some embodiments, a left ear coordinate 116 and a right ear coordinate 117 may be defined relative to the origin point 115 of the user/listener/head coordinate system 114. A matrix (which may include a translation matrix and a Quaternion matrix or other rotation matrix), or other suitable representation can characterize a transformation between the left ear coordinate 116 and the right ear coordinate 117, and user/listener/head coordinate system 114 space. The user/listener/head coordinate system 114 can simplify the representation of locations relative to the user's head, or to a head-mounted device, for example, relative to the environment/world coordinate system 108. Using Simultaneous Localization and Mapping (SLAM), visual odometry, or other techniques, a transformation between user coordinate system 114 and environment coordinate system 108 can be determined and updated in real-time.

FIG. 1B illustrates an example virtual environment 130 that corresponds to real environment 100. The virtual environment 130 shown comprises a virtual rectangular room 104B corresponding to real rectangular room 104A; a virtual object 122B corresponding to real object 122A; a virtual object 124B corresponding to real object 124A; and a virtual object 126B corresponding to real object 126A. Metadata associated with the virtual objects 122B, 124B, 126B can include information derived from the corresponding real objects 122A, 124A, and 126A. Virtual environment 130 additionally comprises a virtual monster 132, which does not correspond to any real object in real environment 100. Real object 128A in real environment 100 does not correspond to any virtual object in virtual environment 130. A persistent coordinate system 133 (comprising an x-axis 133X, a y-axis 133Y, and a z-axis 133Z) with its origin at point 134 (persistent coordinate), can define a coordinate space for virtual content. The origin point 134 of the persistent coordinate system 133 may be defined relative/with respect to one or more real objects, such as the real object 126A. A matrix (which may include a translation matrix and a Quaternion matrix or other rotation matrix), or other suitable representation can characterize a transformation between the persistent coordinate system 133 space and the environment/world coordinate system 108 space. In some embodiments, each of the virtual objects 122B, 124B, 126B, and 132 may have their own persistent coordinate point relative to the origin point 134 of the persistent coordinate system 133. In some embodiments, there may be multiple persistent coordinate systems and each of the virtual objects 122B, 124B, 126B, and 132 may have their own persistent coordinate point relative to one or more persistent coordinate systems.

Persistent coordinate data may be coordinate data that persists relative to a physical environment. Persistent coordinate data may be used by MR systems (e.g., MR system 112, 200) to place persistent virtual content, which may not be tied to movement of a display on which the virtual object is being displayed. For example, a two-dimensional screen may only display virtual objects relative to a position on the screen. As the two-dimensional screen moves, the virtual content may move with the screen. In some embodiments, persistent virtual content may be displayed in a corner of a room. A MR user may look at the corner, see the virtual content, look away from the corner (where the virtual content may no longer be visible because the virtual content may have moved from within the user's field of view to a location outside the user's field of view due to motion of the user's head), and look back to see the virtual content in the corner (similar to how a real object may behave).

In some embodiments, persistent coordinate data (e.g., a persistent coordinate system and/or a persistent coordinate frame) can include an origin point and three axes. For example, a persistent coordinate system may be assigned to a center of a room by a MR system. In some embodiments, a user may move around the room, out of the room, re-enter the room, etc., and the persistent coordinate system may remain at the center of the room (e.g., because it persists relative to the physical environment). In some embodiments, a virtual object may be displayed using a transform to persistent coordinate data, which may enable displaying persistent virtual content. In some embodiments, a MR system may use simultaneous localization and mapping to generate persistent coordinate data (e.g., the MR system may assign a persistent coordinate system to a point in space). In some embodiments, a MR system may map an environment by generating persistent coordinate data at regular intervals (e.g., a MR system may assign persistent coordinate systems in a grid where persistent coordinate systems may be at least within five feet of another persistent coordinate system).

In some embodiments, persistent coordinate data may be generated by a MR system and transmitted to a remote server. In some embodiments, a remote server may be configured to receive persistent coordinate data. In some embodiments, a remote server may be configured to synchronize persistent coordinate data from multiple observation instances. For example, multiple MR systems may map the same room with persistent coordinate data and transmit that data to a remote server. In some embodiments, the remote server may use this observation data to generate canonical persistent coordinate data, which may be based on the one or more observations. In some embodiments, canonical persistent coordinate data may be more accurate and/or reliable than a single observation of persistent coordinate data. In some embodiments, canonical persistent coordinate data may be transmitted to one or more MR systems. For example, a MR system may use image recognition and/or location data to recognize that it is located in a room that has corresponding canonical persistent coordinate data (e.g., because other MR systems have previously mapped the room). In some embodiments, the MR system may receive canonical persistent coordinate data corresponding to its location from a remote server.

With respect to FIGS. 1A and 1B, environment/world coordinate system 108 defines a shared coordinate space for both real environment 100 and virtual environment 130. In the example shown, the coordinate space has its origin at point 106. Further, the coordinate space is defined by the same three orthogonal axes (108X, 108Y, 108Z). Accordingly, a first location in real environment 100, and a second, corresponding location in virtual environment 130, can be described with respect to the same coordinate space. This simplifies identifying and displaying corresponding locations in real and virtual environments, because the same coordinates can be used to identify both locations. However, in some examples, corresponding real and virtual environments need not use a shared coordinate space. For instance, in some examples (not shown), a matrix (which may include a translation matrix and a Quaternion matrix or other rotation matrix), or other suitable representation can characterize a transformation between a real environment coordinate space and a virtual environment coordinate space.

FIG. 1C illustrates an example MRE 150 that simultaneously presents aspects of real environment 100 and virtual environment 130 to user 110 via mixed reality system 112. In the example shown, MRE 150 simultaneously presents user 110 with real objects 122A, 124A, 126A, and 128A from real environment 100 (e.g., via a transmissive portion of a display of mixed reality system 112); and virtual objects 122B, 124B, 126B, and 132 from virtual environment 130 (e.g., via an active display portion of the display of mixed reality system 112). As above, origin point 106 acts as an origin for a coordinate space corresponding to MRE 150, and coordinate system 108 defines an x-axis, y-axis, and z-axis for the coordinate space.

In the example shown, mixed reality objects comprise corresponding pairs of real objects and virtual objects (i.e., 122A/122B, 124A/124B, and 126A/126B) that occupy corresponding locations in coordinate space 108. In some examples, both the real objects and the virtual objects may be simultaneously visible to user 110. This may be desirable in, for example, instances where the virtual object presents information designed to augment a view of the corresponding real object (such as in a museum application where a virtual object presents the missing pieces of an ancient damaged sculpture). In some examples, the virtual objects (122B, 124B, and/or 126B) may be displayed (e.g., via active pixelated occlusion using a pixelated occlusion shutter) so as to occlude the corresponding real objects (122A, 124A, and/or 126A). This may be desirable in, for example, instances where the virtual object acts as a visual replacement for the corresponding real object (such as in an interactive storytelling application where an inanimate real object becomes a “living” character).

In some examples, real objects (e.g., 122A, 124A, 126A) may be associated with virtual content or helper data that may not necessarily constitute virtual objects. Virtual content or helper data can facilitate processing or handling of virtual objects in the mixed reality environment. For example, such virtual content could include two-dimensional representations of corresponding real objects; custom asset types associated with corresponding real objects; or statistical data associated with corresponding real objects. This information can enable or facilitate calculations involving a real object without incurring unnecessary computational overhead.

In some examples, the presentation described above may also incorporate audio aspects. For instance, in MRE 150, virtual monster 132 could be associated with one or more audio signals, such as a footstep sound effect that is generated as the monster walks around MRE 150. As described further below, a processor of mixed reality system 112 can compute an audio signal corresponding to a mixed and processed composite of all such sounds in MRE 150, and present the audio signal to user 110 via one or more speakers included in mixed reality system 112 and/or one or more external speakers.

### Example Mixed Reality System

Example mixed reality system 112 can include a wearable head device (e.g., a wearable augmented reality or mixed reality head device) comprising a display (which may comprise left and right transmissive displays, which may be near-eye displays, and associated components for coupling light from the displays to the user's eyes); left and right speakers (e.g., positioned adjacent to the user's left and right ears, respectively); an inertial measurement unit (IMU) (e.g., mounted to a temple arm of the head device); an orthogonal coil electromagnetic receiver (e.g., mounted to the left temple piece); left and right cameras (e.g., depth (time-of-flight) cameras) oriented away from the user; and left and right eye cameras oriented toward the user (e.g., for detecting the user's eye movements). However, a mixed reality system 112 can incorporate any suitable display technology, and any suitable sensors (e.g., optical, infrared, acoustic, LIDAR, EOG, GPS, magnetic). In addition, mixed reality system 112 may incorporate networking features (e.g., Wi-Fi capability) to communicate with other devices and systems, including other mixed reality systems. Mixed reality system 112 may further include a battery (which may be mounted in an auxiliary unit, such as a belt pack designed to be worn around a user's waist), a processor, and a memory. The wearable head device of mixed reality system 112 may include tracking components, such as an IMU or other suitable sensors, configured to output a set of coordinates of the wearable head device relative to the user's environment. In some examples, tracking components may provide input to a processor performing a Simultaneous Localization and Mapping (SLAM) and/or visual odometry algorithm. In some examples, mixed reality system 112 may also include a handheld controller 300, and/or an auxiliary unit 320, which may be a wearable beltpack, as described further below.

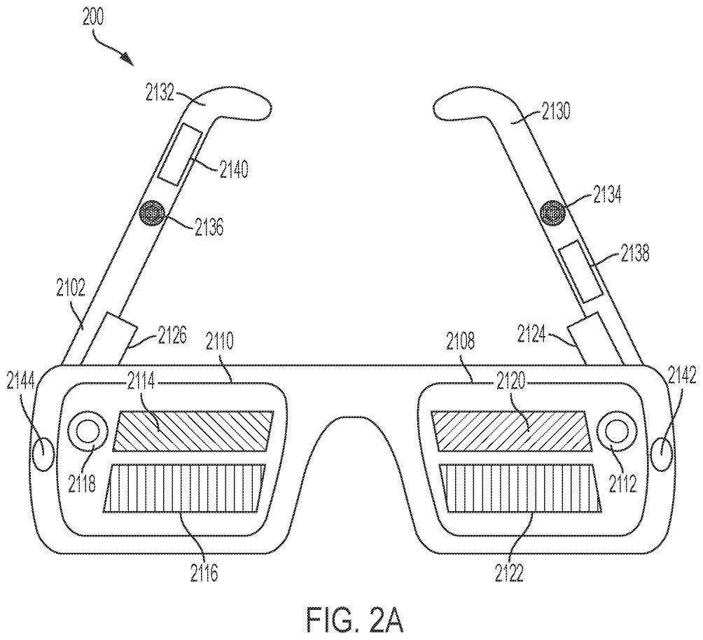

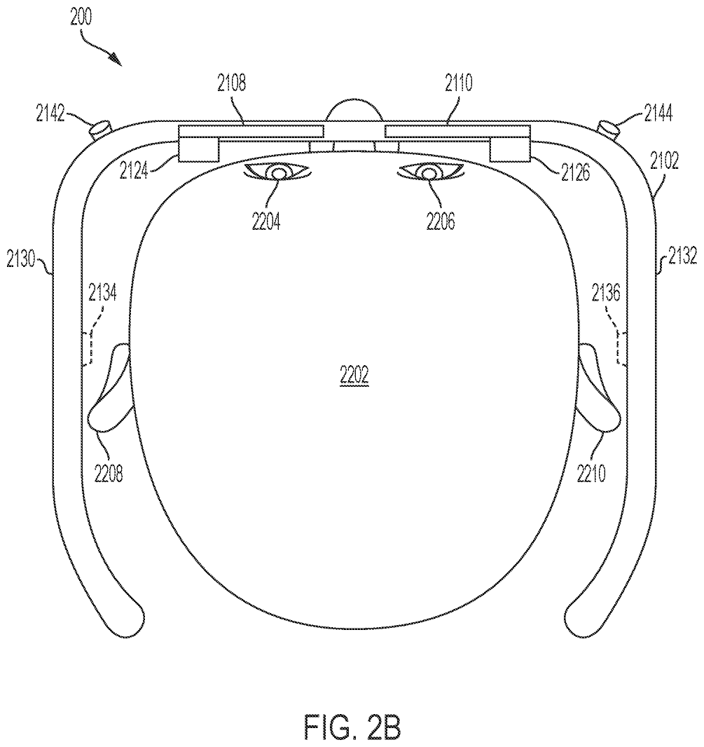

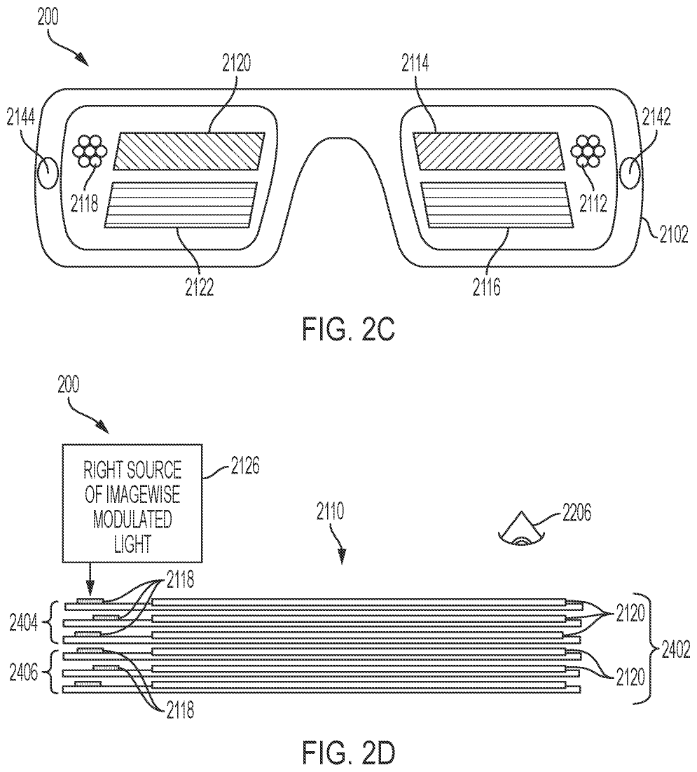

FIGS. 2A-2D illustrate components of an example mixed reality system 200 (which may correspond to mixed reality system 112) that may be used to present a MRE (which may correspond to MRE 150), or other virtual environment, to a user. FIG. 2A illustrates a perspective view of a wearable head device 2102 included in example mixed reality system 200. FIG. 2B illustrates a top view of wearable head device 2102 worn on a user's head 2202. FIG. 2C illustrates a front view of wearable head device 2102. FIG. 2D illustrates an edge view of example eyepiece 2110 of wearable head device 2102. As shown in FIGS. 2A-2C, the example wearable head device 2102 includes an example left eyepiece (e.g., a left transparent waveguide set eyepiece) 2108 and an example right eyepiece (e.g., a right transparent waveguide set eyepiece) 2110. Each eyepiece 2108 and 2110 can include transmissive elements through which a real environment can be visible, as well as display elements for presenting a display (e.g., via imagewise modulated light) overlapping the real environment. In some examples, such display elements can include surface diffractive optical elements for controlling the flow of imagewise modulated light. For instance, the left eyepiece 2108 can include a left in-coupling grating set 2112, a left orthogonal pupil expansion (OPE) grating set 2120, and a left exit (output) pupil expansion (EPE) grating set 2122. As used herein, a pupil may refer to the exit of light from an optical element such as a grating set or reflector. Similarly, the right eyepiece 2110 can include a right in-coupling grating set 2118, a right OPE grating set 2114 and a right EPE grating set 2116. Imagewise modulated light can be transferred to a user's eye via the in-coupling gratings 2112 and 2118, OPEs 2114 and 2120, and EPE 2116 and 2122. Each in-coupling grating set 2112, 2118 can be configured to deflect light toward its corresponding OPE grating set 2120, 2114. Each OPE grating set 2120, 2114 can be designed to incrementally deflect light down toward its associated EPE 2122, 2116, thereby horizontally extending an exit pupil being formed. Each EPE 2122, 2116 can be configured to incrementally redirect at least a portion of light received from its corresponding OPE grating set 2120, 2114 outward to a user eyebox position (not shown) defined behind the eyepieces 2108, 2110, vertically extending the exit pupil that is formed at the eyebox. Alternatively, in lieu of the in-coupling grating sets 2112 and 2118, OPE grating sets 2114 and 2120, and EPE grating sets 2116 and 2122, the eyepieces 2108 and 2110 can include other arrangements of gratings and/or refractive and reflective features for controlling the coupling of imagewise modulated light to the user's eyes.

In some examples, wearable head device 2102 can include a left temple arm 2130 and a right temple arm 2132, where the left temple arm 2130 includes a left speaker 2134 and the right temple arm 2132 includes a right speaker 2136. An orthogonal coil electromagnetic receiver 2138 can be located in the left temple piece, or in another suitable location in the wearable head unit 2102. An Inertial Measurement Unit (IMU) 2140 can be located in the right temple arm 2132, or in another suitable location in the wearable head device 2102. The wearable head device 2102 can also include a left depth (e.g., time-of-flight) camera 2142 and a right depth camera 2144. The depth cameras 2142, 2144 can be suitably oriented in different directions so as to together cover a wider field of view.

In the example shown in FIGS. 2A-2D, a left source of imagewise modulated light 2124 can be optically coupled into the left eyepiece 2108 through the left in-coupling grating set 2112, and a right source of imagewise modulated light 2126 can be optically coupled into the right eyepiece 2110 through the right in-coupling grating set 2118. Sources of imagewise modulated light 2124, 2126 can include, for example, optical fiber scanners; projectors including electronic light modulators such as Digital Light Processing (DLP) chips or Liquid Crystal on Silicon (LCoS) modulators; or emissive displays, such as micro Light Emitting Diode (μLED) or micro Organic Light Emitting Diode (μOLED) panels coupled into the in-coupling grating sets 2112, 2118 using one or more lenses per side. The input coupling grating sets 2112, 2118 can deflect light from the sources of imagewise modulated light 2124, 2126 to angles above the critical angle for Total Internal Reflection (TIR) for the eyepieces 2108, 2110. The OPE grating sets 2114, 2120 incrementally deflect light propagating by TIR down toward the EPE grating sets 2116, 2122. The EPE grating sets 2116, 2122 incrementally couple light toward the user's face, including the pupils of the user's eyes.

In some examples, as shown in FIG. 2D, each of the left eyepiece 2108 and the right eyepiece 2110 includes a plurality of waveguides 2402. For example, each eyepiece 2108, 2110 can include multiple individual waveguides, each dedicated to a respective color channel (e.g., red, blue and green). In some examples, each eyepiece 2108, 2110 can include multiple sets of such waveguides, with each set configured to impart different wavefront curvature to emitted light. The wavefront curvature may be convex with respect to the user's eyes, for example to present a virtual object positioned a distance in front of the user (e.g., by a distance corresponding to the reciprocal of wavefront curvature). In some examples, EPE grating sets 2116, 2122 can include curved grating grooves to effect convex wavefront curvature by altering the Poynting vector of exiting light across each EPE.

In some examples, to create a perception that displayed content is three-dimensional, stereoscopically-adjusted left and right eye imagery can be presented to the user through the imagewise light modulators 2124, 2126 and the eyepieces 2108, 2110. The perceived realism of a presentation of a three-dimensional virtual object can be enhanced by selecting waveguides (and thus corresponding the wavefront curvatures) such that the virtual object is displayed at a distance approximating a distance indicated by the stereoscopic left and right images. This technique may also reduce motion sickness experienced by some users, which may be caused by differences between the depth perception cues provided by stereoscopic left and right eye imagery, and the autonomic accommodation (e.g., object distance-dependent focus) of the human eye.

FIG. 2D illustrates an edge-facing view from the top of the right eyepiece 2110 of example wearable head device 2102. As shown in FIG. 2D, the plurality of waveguides 2402 can include a first subset of three waveguides 2404 and a second subset of three waveguides 2406. The two subsets of waveguides 2404, 2406 can be differentiated by different EPE gratings featuring different grating line curvatures to impart different wavefront curvatures to exiting light. Within each of the subsets of waveguides 2404, 2406 each waveguide can be used to couple a different spectral channel (e.g., one of red, green and blue spectral channels) to the user's right eye 2206. (Although not shown in FIG. 2D, the structure of the left eyepiece 2108 is analogous to the structure of the right eyepiece 2110.)

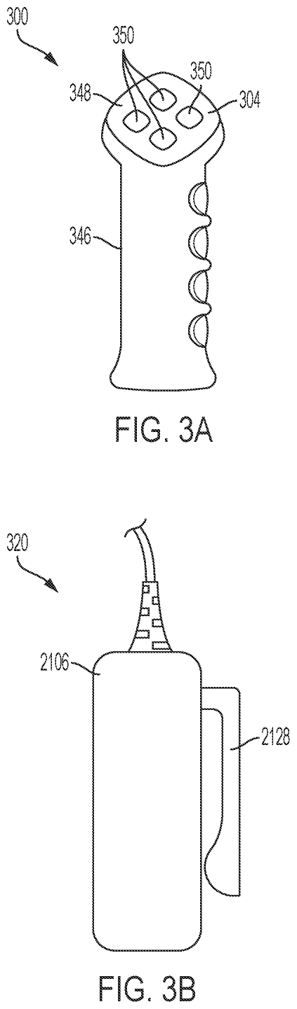

FIG. 3A illustrates an example handheld controller component 300 of a mixed reality system 200. In some examples, handheld controller 300 includes a grip portion 346 and one or more buttons 350 disposed along a top surface 348. In some examples, buttons 350 may be configured for use as an optical tracking target, e.g., for tracking six-degree-of-freedom (6DOF) motion of the handheld controller 300, in conjunction with a camera or other optical sensor (which may be mounted in a head unit (e.g., wearable head device 2102) of mixed reality system 200). In some examples, handheld controller 300 includes tracking components (e.g., an IMU or other suitable sensors) for detecting position or orientation, such as position or orientation relative to wearable head device 2102. In some examples, such tracking components may be positioned in a handle of handheld controller 300, and/or may be mechanically coupled to the handheld controller. Handheld controller 300 can be configured to provide one or more output signals corresponding to one or more of a pressed state of the buttons; or a position, orientation, and/or motion of the handheld controller 300 (e.g., via an IMU). Such output signals may be used as input to a processor of mixed reality system 200. Such input may correspond to a position, orientation, and/or movement of the handheld controller (and, by extension, to a position, orientation, and/or movement of a hand of a user holding the controller). Such input may also correspond to a user pressing buttons 350.

FIG. 3B illustrates an example auxiliary unit 320 of a mixed reality system 200. The auxiliary unit 320 can include a battery to provide energy to operate the system 200, and can include a processor for executing programs to operate the system 200. As shown, the example auxiliary unit 320 includes a clip 2128, such as for attaching the auxiliary unit 320 to a user's belt. Other form factors are suitable for auxiliary unit 320 and will be apparent, including form factors that do not involve mounting the unit to a user's belt. In some examples, auxiliary unit 320 is coupled to the wearable head device 2102 through a multiconduit cable that can include, for example, electrical wires and fiber optics. Wireless connections between the auxiliary unit 320 and the wearable head device 2102 can also be used.

In some examples, mixed reality system 200 can include one or more microphones to detect sound and provide corresponding signals to the mixed reality system. In some examples, a microphone may be attached to, or integrated with, wearable head device 2102, and may be configured to detect a user's voice. In some examples, a microphone may be attached to, or integrated with, handheld controller 300 and/or auxiliary unit 320. Such a microphone may be configured to detect environmental sounds, ambient noise, voices of a user or a third party, or other sounds.

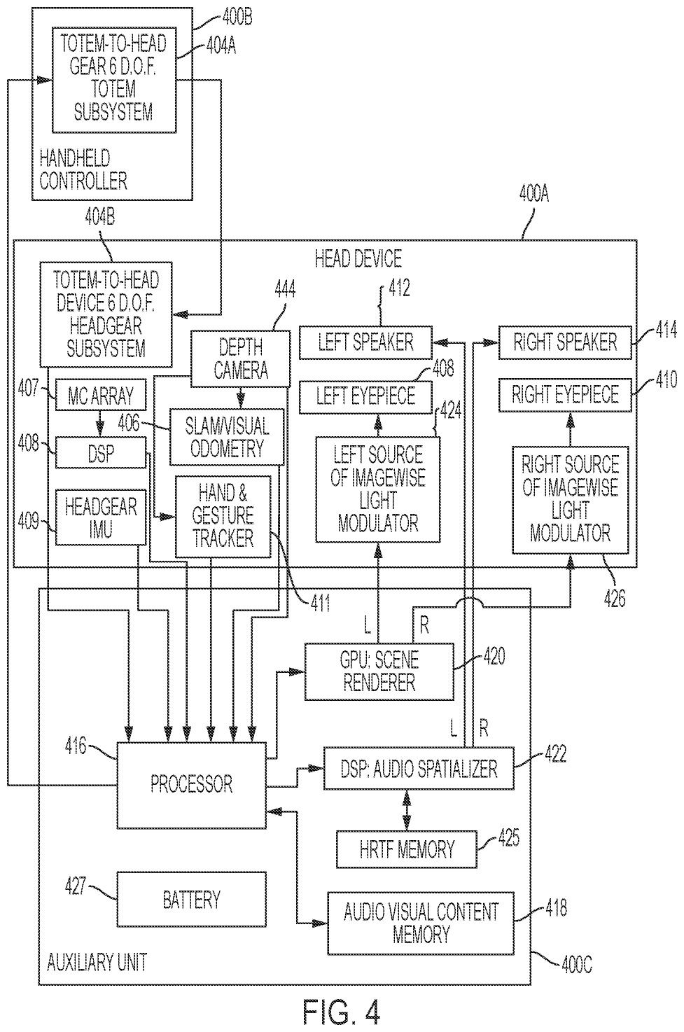

FIG. 4 shows an example functional block diagram that may correspond to an example mixed reality system, such as mixed reality system 200 described above (which may correspond to mixed reality system 112 with respect to FIG. 1). As shown in FIG. 4, example handheld controller 400B (which may correspond to handheld controller 300 (a “totem”)) includes a totem-to-wearable head device six degree of freedom (6DOF) totem subsystem 404A and example wearable head device 400A (which may correspond to wearable head device 2102) includes a totem-to-wearable head device 6DOF subsystem 404B. In the example, the 6DOF totem subsystem 404A and the 6DOF subsystem 404B cooperate to determine six coordinates (e.g., offsets in three translation directions and rotation along three axes) of the handheld controller 400B relative to the wearable head device 400A. The six degrees of freedom may be expressed relative to a coordinate system of the wearable head device 400A. The three translation offsets may be expressed as X, Y, and Z offsets in such a coordinate system, as a translation matrix, or as some other representation. The rotation degrees of freedom may be expressed as sequence of yaw, pitch and roll rotations, as a rotation matrix, as a quaternion, or as some other representation. In some examples, the wearable head device 400A; one or more depth cameras 444 (and/or one or more non-depth cameras) included in the wearable head device 400A; and/or one or more optical targets (e.g., buttons 350 of handheld controller 400B as described above, or dedicated optical targets included in the handheld controller 400B) can be used for 6DOF tracking. In some examples, the handheld controller 400B can include a camera, as described above; and the wearable head device 400A can include an optical target for optical tracking in conjunction with the camera. In some examples, the wearable head device 400A and the handheld controller 400B each include a set of three orthogonally oriented solenoids which are used to wirelessly send and receive three distinguishable signals. By measuring the relative magnitude of the three distinguishable signals received in each of the coils used for receiving, the 6DOF of the wearable head device 400A relative to the handheld controller 400B may be determined. Additionally, 6DOF totem subsystem 404A can include an Inertial Measurement Unit (IMU) that is useful to provide improved accuracy and/or more timely information on rapid movements of the handheld controller 400B.

In some embodiments, wearable system 400 can include microphone array 407, which can include one or more microphones arranged on headgear device 400A. In some embodiments, microphone array 407 can include four microphones. Two microphones can be placed on a front face of headgear 400A, and two microphones can be placed at a rear of head headgear 400A (e.g., one at a back-left and one at a back-right). In some embodiments, signals received by microphone array 407 can be transmitted to DSP 408. DSP 408 can be configured to perform signal processing on the signals received from microphone array 407. For example, DSP 408 can be configured to perform noise reduction, acoustic echo cancellation, and/or beamforming on signals received from microphone array 407. DSP 408 can be configured to transmit signals to processor 416.

In some examples, it may become necessary to transform coordinates from a local coordinate space (e.g., a coordinate space fixed relative to the wearable head device 400A) to an inertial coordinate space (e.g., a coordinate space fixed relative to the real environment), for example in order to compensate for the movement of the wearable head device 400A relative to the coordinate system 108. For instance, such transformations may be necessary for a display of the wearable head device 400A to present a virtual object at an expected position and orientation relative to the real environment (e.g., a virtual person sitting in a real chair, facing forward, regardless of the wearable head device's position and orientation), rather than at a fixed position and orientation on the display (e.g., at the same position in the right lower corner of the display), to preserve the illusion that the virtual object exists in the real environment (and does not, for example, appear positioned unnaturally in the real environment as the wearable head device 400A shifts and rotates). In some examples, a compensatory transformation between coordinate spaces can be determined by processing imagery from the depth cameras 444 using a SLAM and/or visual odometry procedure in order to determine the transformation of the wearable head device 400A relative to the coordinate system 108. In the example shown in FIG. 4, the depth cameras 444 are coupled to a SLAM/visual odometry block 406 and can provide imagery to block 406. The SLAM/visual odometry block 406 implementation can include a processor configured to process this imagery and determine a position and orientation of the user's head, which can then be used to identify a transformation between a head coordinate space and another coordinate space (e.g., an inertial coordinate space). Similarly, in some examples, an additional source of information on the user's head pose and location is obtained from an IMU 409. Information from the IMU 409 can be integrated with information from the SLAM/visual odometry block 406 to provide improved accuracy and/or more timely information on rapid adjustments of the user's head pose and position.

In some examples, the depth cameras 444 can supply 3D imagery to a hand gesture tracker 411, which may be implemented in a processor of the wearable head device 400A. The hand gesture tracker 411 can identify a user's hand gestures, for example by matching 3D imagery received from the depth cameras 444 to stored patterns representing hand gestures. Other suitable techniques of identifying a user's hand gestures will be apparent.

In some examples, one or more processors 416 may be configured to receive data from the wearable head device's 6DOF headgear subsystem 404B, the IMU 409, the SLAM/visual odometry block 406, depth cameras 444, and/or the hand gesture tracker 411. The processor 416 can also send and receive control signals from the 6DOF totem system 404A. The processor 416 may be coupled to the 6DOF totem system 404A wirelessly, such as in examples where the handheld controller 400B is untethered. Processor 416 may further communicate with additional components, such as an audio-visual content memory 418, a Graphical Processing Unit (GPU) 420, and/or a Digital Signal Processor (DSP) audio spatializer 422. The DSP audio spatializer 422 may be coupled to a Head Related Transfer Function (HRTF) memory 425. The GPU 420 can include a left channel output coupled to the left source of imagewise modulated light 424 and a right channel output coupled to the right source of imagewise modulated light 426. GPU 420 can output stereoscopic image data to the sources of imagewise modulated light 424, 426, for example as described above with respect to FIGS. 2A-2D. The DSP audio spatializer 422 can output audio to a left speaker 412 and/or a right speaker 414. The DSP audio spatializer 422 can receive input from processor 419 indicating a direction vector from a user to a virtual sound source (which may be moved by the user, e.g., via the handheld controller 320). Based on the direction vector, the DSP audio spatializer 422 can determine a corresponding HRTF (e.g., by accessing a HRTF, or by interpolating multiple HRTFs). The DSP audio spatializer 422 can then apply the determined HRTF to an audio signal, such as an audio signal corresponding to a virtual sound generated by a virtual object. This can enhance the believability and realism of the virtual sound, by incorporating the relative position and orientation of the user relative to the virtual sound in the mixed reality environment—that is, by presenting a virtual sound that matches a user's expectations of what that virtual sound would sound like if it were a real sound in a real environment.

In some examples, such as shown in FIG. 4, one or more of processor 416, GPU 420, DSP audio spatializer 422, HRTF memory 425, and audio/visual content memory 418 may be included in an auxiliary unit 400C (which may correspond to auxiliary unit 320 described above). The auxiliary unit 400C may include a battery 427 to power its components and/or to supply power to the wearable head device 400A or handheld controller 400B. Including such components in an auxiliary unit, which can be mounted to a user's waist, can limit the size and weight of the wearable head device 400A, which can in turn reduce fatigue of a user's head and neck.

While FIG. 4 presents elements corresponding to various components of an example mixed reality system, various other suitable arrangements of these components will become apparent to those skilled in the art. For example, elements presented in FIG. 4 as being associated with auxiliary unit 400C could instead be associated with the wearable head device 400A or handheld controller 400B. Furthermore, some mixed reality systems may forgo entirely a handheld controller 400B or auxiliary unit 400C. Such changes and modifications are to be understood as being included within the scope of the disclosed examples.

### Encapsulation Layer for Illumination Layer

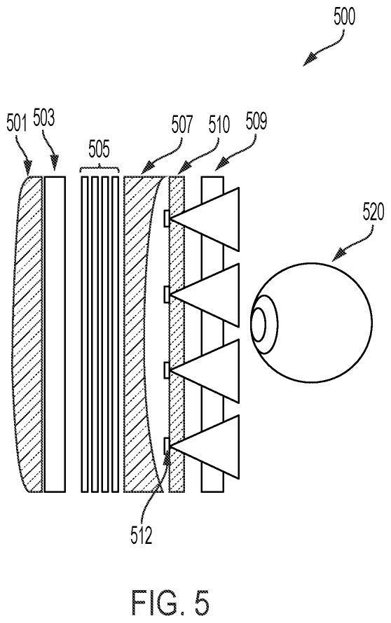

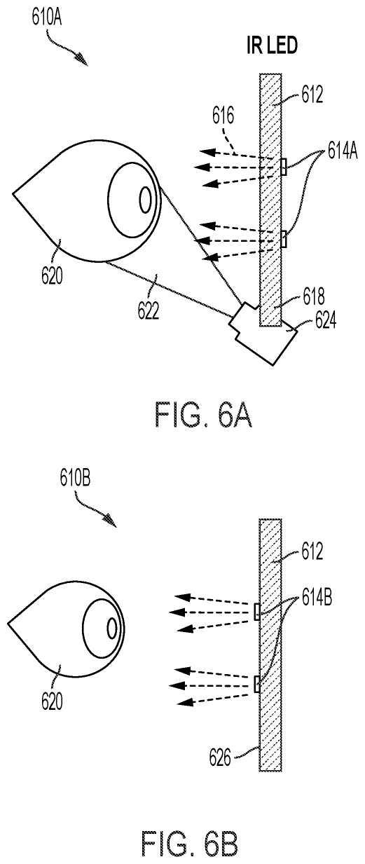

A wearable head device or head mounted display of an example mixed reality system (e.g., mixed reality system 200) may include an optical system for presenting an image to a user via the display. The example optical system may further include eye-tracking capabilities. For example, FIGS. 5 and 6A-6B illustrate examples of an optical system and/or illumination layer that can be used in a wearable head device (e.g., wearable head device 2102) according to embodiments of this disclosure.

FIG. 5 illustrates an example optical system 500 that may be used in a wearable head device (e.g., wearable head device 2102). As shown in the figure, the optical system 500 can include a plurality of optical components arranged in layers. For example, the optical system 500 may include one or more of an outer lens 501, a dimmer 503, an eyepiece 505, an inner lens 507, an IR illumination layer 510, and a corrective prescription insert 509. The optical system 500 may be configured to present a digital image to the eye 520 of a user, present a view of the user's environment, and/or track movement of the user's eye. The outer lens and inner lens may provide a view of the user's environment and/or digital image that is in focus. The dimmer 503 can be provided to adjust the amount of light that enters the optical system from the user's environment. The eyepiece 505 can be provided to present digital content to a user. The IR illumination layer 510 (also referred to herein as an illumination layer) can be provided to facilitate eye-tracking capabilities. The corrective prescription insert 509 may be provided to tailor the optical system to a specific user's eyesight. The drawings are included for illustrative purposes and may not necessarily be to scale, indicate the relative thickness of the layers, and/or the actual dimensions of the layers.

FIG. 6A illustrates an example illumination layer 610A according to embodiments of this disclosure. The illumination layer 610A may be included in an optical system, e.g., optical system 500. As shown in the figure, the illumination layer 610A may include a substrate 612 and one or more LEDs 614A. In some embodiments, the illumination layer may include one or more metal traces (not shown) that are connected to the one or more LEDs 614A. The LEDs 614A may be IR LEDs that correspond to a wavelength in the IR range. As shown in the figure, the one or more LEDs 614A may be disposed on a back surface 618 of the substrate 612. The LEDs 614A may provide IR illumination light 616 to the eye 620 of a user. The IR illumination light may be reflected off the surface of the eye 620 to form IR eye reflected light 622. A portion of the IR reflected light 622 may be received at a light sensor 624. In some embodiments, the light sensor 624 may be located near an outer edge of the illumination layer 610A, e.g., at an edge of the optical system stack 500. In some examples, the light sensor 624 may be a part of the optical system but not be physically disposed on the illumination layer. The received portion of the IR reflected light 622 can be processed by the MR system to track eye movement of the eye 620.

FIG. 6B illustrates an example illumination layer 610B according to embodiments of this disclosure. The illumination layer 610B may be included in an optical system, e.g., optical system 500. As shown in the figure, the illumination layer 610B may include a substrate 612 and one or more LEDs 614B. As shown in the figure, the one or more LEDs 614B may be disposed on a front surface 626 of the substrate 612. In some embodiments, the illumination layer may include one or more metal traces (not shown) that are connected to the one or more LEDs 614B. The LEDs 614B may provide IR illumination light 616 to the eye of a user as discussed with respect to FIG. 6A. The LEDs 614B may be IR LEDs that correspond to a wavelength in the IR range.

In some embodiments, the substrate 612 may be a flexible or rigid substrate formed from a polymer layer laminated on a carrier plate, e.g., glass carrier plate. For example, the substrate may include a polycarbonate (PC), polyethylene terephthalate (PET), and/or triacetate cellulose (TAC) laminated on a glass carrier plate. While the polymer materials forming the substrate 612 may be relatively inexpensive and mechanically reliable, the substrate 612 may be prone to light transmission loss due to reflection and/or haze, as well as light transmission loss at the interface between materials, e.g., at the polymer/glass interface. Moreover, polymer materials can be prone to processing issues such as surface chemical attack, swelling, and may be less scratch resistant, which all can contribute to reduced light transmission and increased haze. The loss of light transmission and haze can affect the amount of environment light that passes through the optical system, e.g., optical system 500, and impact the quality of the digital image presented to the user.

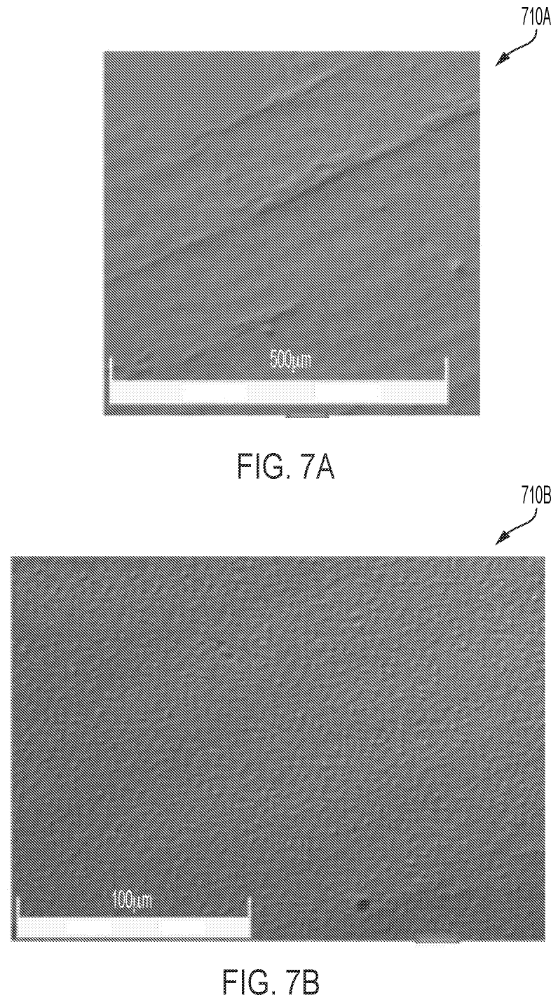

FIGS. 7A and 7B are photos of a portion of a polymer layer, e.g., polymer illumination layer that illustrate haze on a surface of the polymer layer that can affect transmittance. For example, the polymer layer 710A may correspond to a zoomed out view of polymer layer 710B. As shown in the figures, the surface of the polymer layer 710A, 710B may be rough and/or uneven, which can contribute to its hazy appearance. For example, the surface can include a number of irregular undulations that contribute to the uneven surface texture. In some examples, a polymer layer, e.g., 710A and 710B, can have a measured haze value of about 1.00-1.65%. By comparison, a glass illumination layer may have a measured haze value of about 0.24%.

FIG. 7C illustrates a profile of an illumination layer according to embodiments of this disclosure. As shown in the figure, the illumination layer 710C can include a substrate 712C that may have a rough or uneven top surface 718C. For example, the surface may include a number of irregular undulations that contribute to the uneven surface texture. The uneven surface may contribute to a visible hazy appearance, see e.g., FIGS. 7A and 7B, and contribute to a decrease in transmittance. FIG. 7D illustrates an illumination layer according to embodiments of this disclosure. As shown in the figure, the illumination layer 710D can include a substrate 712D that may have a rough or uneven top surface 718D and bottom surface 720D, as discussed above with respect to surface 718C.

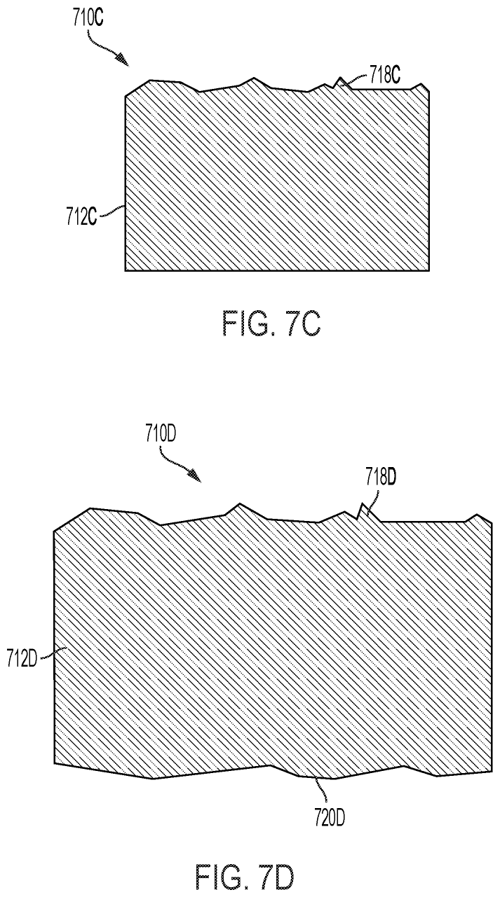

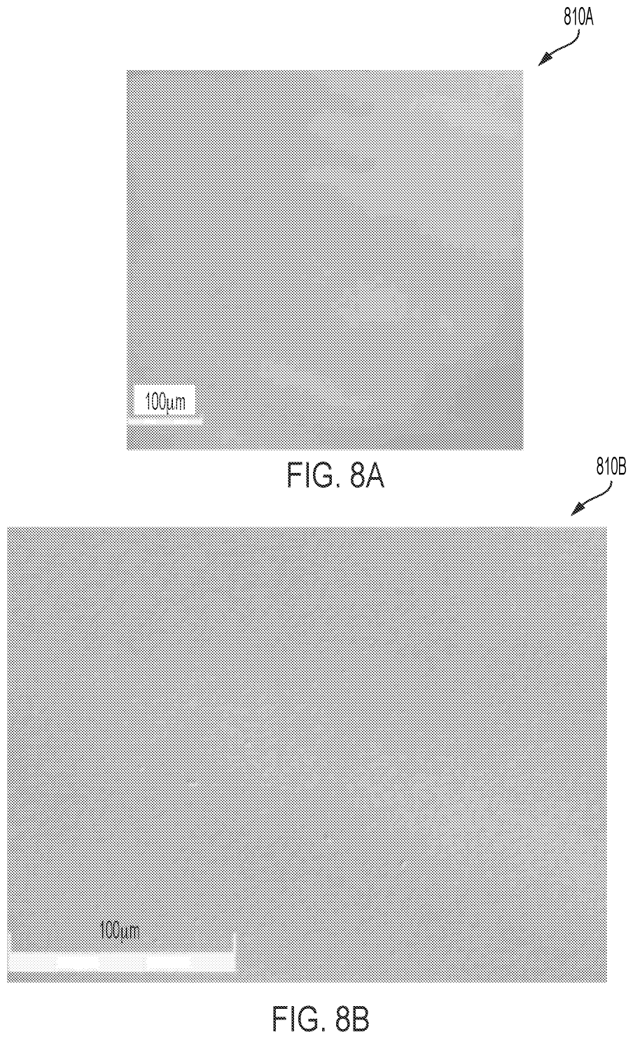

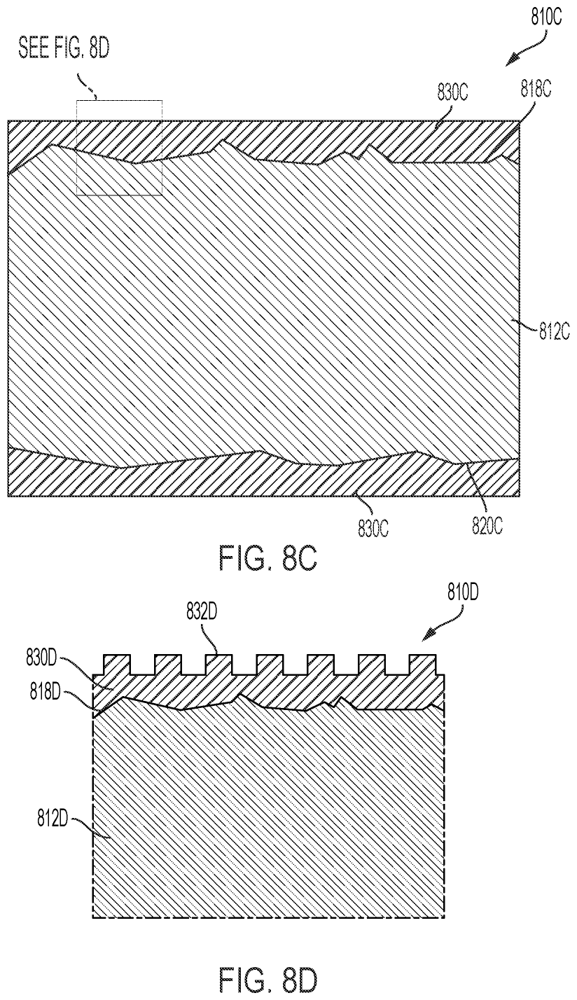

FIGS. 8A and 8B are photos of a portion of a polymer layer 810, e.g., polymer illumination layer that includes an encapsulation layer according to embodiments of this disclosure. In some examples, the polymer layer 810A may correspond to a zoomed out view of polymer layer 810B. As shown in the figures, the surface texture of the polymer layer 810A, 810B may be relatively smooth compared to the surface texture of polymer layers 710A and 710B. For example, a polymer layer that includes an encapsulation layer, e.g., 810A and 700B, can have a measured haze value of about 0.11%.

FIG. 8C illustrates a profile of an illumination layer 810C according to embodiments of this disclosure. For example, as shown in FIG. 8C, the illumination layer 810C can include an encapsulation layer 830C disposed on a top surface 818C and/or a bottom surface 820C of the substrate 812C of the illumination layer 810C. While the encapsulation layer is shown on both the top and bottom surface, a skilled artisan will understand that according to embodiments of this disclosure, the encapsulation layer can be disposed on either the top or bottom surface.

FIG. 8D can correspond to a detailed view of the illumination layer 810C, according to embodiments of this disclosure. For example, as shown in this figure, the encapsulation layer 830D may be provided to planarize the surface 818D of the substrate 812D. As used herein, the term planarize may refer to smoothing, filling, and/or flattening an uneven surface texture. In some embodiments, the encapsulation layer, e.g., 830C, 830D, may include an anti-reflective nano-pattern 832D that planarizes the surface 818 of the substrate, e.g., 812C, 812D. The encapsulation layer may improve transmittance and reduce haze by planarizing the irregular undulations of surface. Moreover, the encapsulation layer may act as an anti-scratch layer of protection on the substrate (e.g., 812C, 812D) of the illumination layer 810.

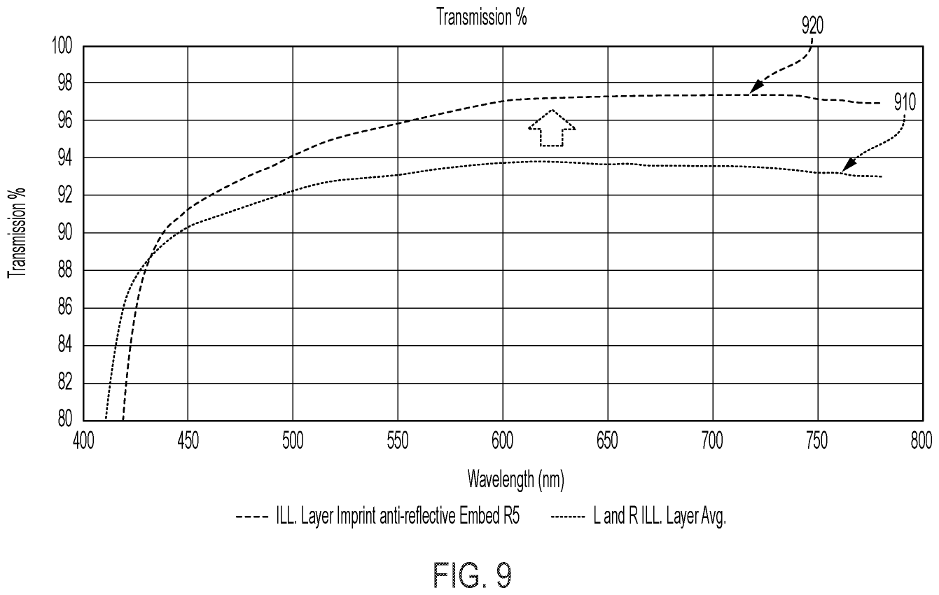

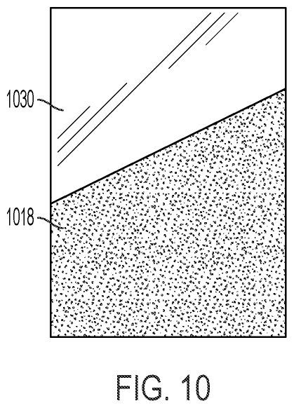

FIG. 9 is a graph that illustrates an exemplary improvement in transmittance of an illumination layer, where an encapsulation layer such as described above embeds one or more LEDs. Line 910 illustrates transmittance over various wavelengths for an illumination layer that does not include an encapsulation layer, e.g., illumination layer 610A, 610B. Line 920 illustrates transmittance over various wavelengths for an illumination layer that includes an encapsulation layer, e.g., illumination layer 810. FIG. 10 illustrates a diagrammatic difference between a planarized portion 1030 and an unplanarized portion 1018 of an illumination layer 1010. As shown the planarized portion 1030 can be relatively transmissive compared to the unplanarized portion 1018. For example, the transmittance of unplanarized portion 1018 may correspond to line 910 of FIG. 9, while planarized portion 1010 can correspond to line 920.

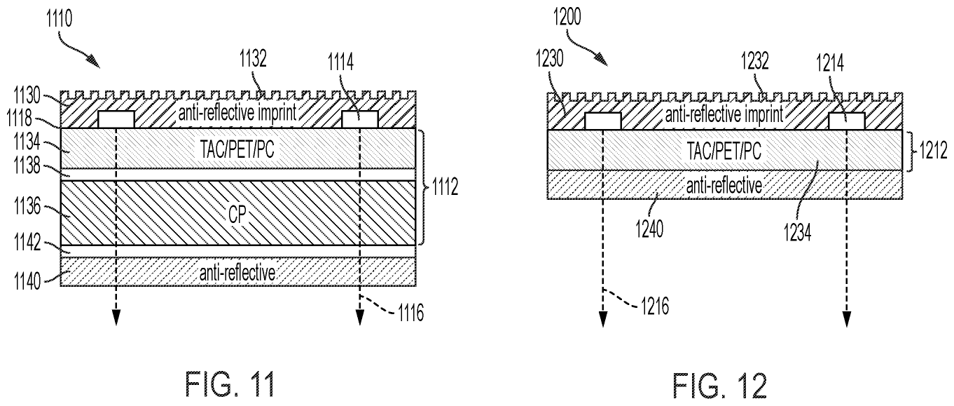

FIGS. 11-16 illustrate exemplary illumination layers for a MR system according to embodiments of this disclosure. The illumination layers may include a substrate, one or more LEDs, and an encapsulation layer. In some embodiments, the substrate may include an anti-reflective coating disposed on the substrate. In some embodiments, the illumination layer may include a second encapsulation layer. In some embodiments, the second encapsulation layer can have a radius of curvature.

FIG. 11 illustrates an exemplary illumination layer for a MR system according to embodiments of this disclosure. As shown in the figure, the illumination layer 1110 can include a substrate 1112, one or more LEDs 1114, and an encapsulation layer 1130. In one or more examples, the one or more LEDs 1114 may be mounted on a rear surface of the substrate 1112. The one or more LEDs may be configured to project light 1116 through the substrate 1112 and toward an eye of a user (not shown). Illumination layer 1110 may be characterized as a backlit illumination layer.

As shown in the figure, the substrate 1112 of the illumination layer 1110 may include a polymer layer 1134 disposed on a carrier plate (CP) 1136. The polymer layer 1134 may be formed from, for example, PET, PC, and TAC. In some embodiments, the carrier plate 1136 may be formed from a glass plate. The carrier plate 1136 may provide additional rigidity to the substrate 1112. In some embodiments, an index-matching layer 1138 may located between the polymer layer 1134 and the carrier plate 1136. The index-matching layer 1138 may be provided to reduce undesirable reflections and/or refractions at the interface between the polymer layer 1134 and the carrier plate 1136. In some embodiments, the illumination layer 1110 can include an anti-reflective coating 1140 disposed on a front surface of the substrate, e.g., opposite the encapsulation layer 1130. In some embodiments, a second index-matching layer 1142 may be disposed between the carrier plate 1136 and the anti-reflective coating 1140.

The encapsulation layer 1130 may include a nano-patterned surface 1132. As shown in the figure, the nano-patterned surface 1132 may be located on a rear surface of the encapsulation layer 1130. As discussed above, the nano-patterned surface 1132 of the encapsulation layer 1130 may planarize and reduce loss of transmission associated with surface imperfections and undulations of the substrate 1112, e.g., the polymer layer 1134 of the substrate 1112. For example, nano-patterned surface 1132 can reduce visible light reflections, e.g., reduce haze and improve transmittance. Various pattern types will be discussed below in more detail. However, the skilled artisan will understand that any suitable nano-patterned surface having anti-reflective properties may be used without departing from the scope of this disclosure. Moreover, the encapsulation layer 1130 may improve the mechanical stability of the substrate 1112A by adding further rigidity to the illumination layer 1110.

In some embodiments, the encapsulation layer 1130 may be disposed on a rear surface of the substrate 1112, such that the encapsulation layer 1130 is disposed over the one or more LEDs 1114, i.e., the one or more LEDs 1114 are covered by the encapsulation layer 1130. In some embodiments, the illumination layer 1110 can include one or more leads (not shown). The one or more lead lines may connect the one or more LEDs 1114 to other circuitry, e.g., a power source not located on the illumination layer 1110. The one or more lead lines may be formed from copper, silver, and/or other suitable materials known in the art.

As shown in the figure, the encapsulation layer 1130 can cover the one or more LEDs 1114 and/or lead lines. In this manner, the encapsulation layer 1130 may further act to passivate the one or more LEDs 1114 and/or lead lines. Referring briefly to illumination layers 610A and 610B, the one or more LEDs 614A, 614B and lead lines (not shown) disposed on the substrate 612 can be exposed to air and ambient conditions and humidity, leading to corrosion. Corrosion due to exposure to ambient conditions can be undesirable as it may lead in a decrease in performance of the components. In comparison, illumination layers according to embodiments of this disclosure can include an encapsulation layer 1130 which can cover the one or more LEDs 1114 and lead lines (not shown), thereby sealing these components from exposure to ambient conditions. For example, if the one or more LEDs has a height of about 250 μm, the encapsulation layer 1130 may have a height of about 300 μm. Thus, the encapsulation layer 1130 can embed and passivate the one or more LEDs 1114 and/or lead lines.

Accordingly, encapsulation layer 1130 may improve transmittance and reduced haze of illumination layer 1110. Moreover, the encapsulation layer 1130 may improve the mechanical stability of the substrate 1112. Further, the encapsulation layer 1130 can embed and passivate the one or more LEDs 1114 and/or lead lines.

FIG. 12 illustrates an exemplary illumination layer 1210 for an example MR system according to embodiments of this disclosure. Illumination layer 1210 can include a substrate 1212, one or more LEDs 1214, and an encapsulation layer 1230. In some embodiments, the substrate 1212 can be formed from a polymer layer 1234. For example, in comparison to illumination layer 1110, illumination 1210 need not include a carrier plate, e.g., carrier plate 1136. In this manner, the illumination layer 1210 may have a greater flexibility compared to illumination layer 1110.

In some embodiments, one or more features of the illumination layer 1210 (e.g., apart from substrate 1112) may be similar to illumination layer 1110. For example, as shown in the figure, the encapsulation layer 1230 may be disposed on a rear surface of the substrate 1212, such that the encapsulation layer 1230 is disposed over the one or more LEDs 1214, i.e., the one or more LEDs 1214 are covered by the encapsulation layer 1230. The encapsulation layer 1230 may include a rear-patterned surface 1232. The patterned surface 1232 may be similar to patterned surfaces 832, 1132 described above. In some embodiments, the illumination layer 1210 can include one or more leads (not shown). In some embodiments, the illumination layer 1210 can include an anti-reflective coating 1240 disposed on a front surface of the substrate, e.g., opposite the encapsulation layer 1230. Accordingly, illumination layer 1210 may provide improved transmittance and reduced haze compared to, for example, illumination layer 610A, 610B. Moreover, the encapsulation layer 1230 of illumination layer 1210 may improve the mechanical stability of the substrate 1212, with the additional bonded layer of material. Further, the encapsulation layer 1230 of illumination layer 1210 can embed and passivate the one or more LEDs 1214 and/or lead lines.

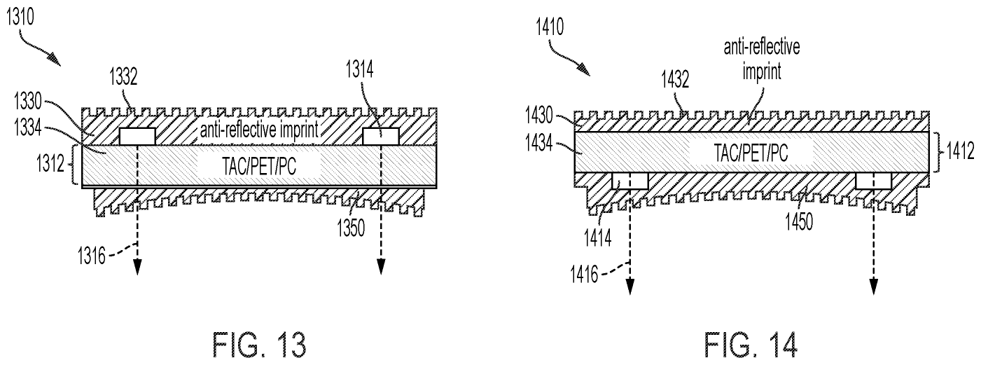

FIG. 13 illustrates an exemplary illumination layer 1310 for an example MR system according to embodiments of this disclosure. Illumination layer 1310 can include a substrate 1312, one or more LEDs 1314, a first encapsulation layer 1330 and a second encapsulation layer 1350. The illumination layer 1310 may be a front lit illumination layer. In some embodiments, the substrate 1312 can be formed from a polymer layer 1334, similar to substrate 1212.

In some embodiments, features of the illumination layer 1310 may be analogous to illumination layers 1310 and 1210. For example, as shown in the figure, the first encapsulation layer 1330 may be disposed on a rear surface of the substrate 1312, such that the first encapsulation layer 1330 can be disposed over the one or more LEDs 1314, i.e., the one or more LEDs 1314 can be covered by the first encapsulation layer 1330. The first encapsulation layer 1330 may include a first patterned surface 1332. The patterned surface may be similar to patterned surface 832 described above, e.g., the patterned surface 1332 may have anti-reflective properties. In some embodiments, the illumination layer 1310 can include one or more lead lines (not shown). Accordingly, illumination layer 1310 may provide improved transmittance and reduced haze compared to, for example, illumination layer 610A, 610B. Moreover, the first encapsulation layer 1330 of illumination layer 1310 may improve the mechanical stability of the illumination layer 1310 by increasing the thickness of the illumination layer 1310. Further, the encapsulation layer 1330 of illumination layer 1310B can embed and passivate the one or more LEDs 1314 and/or lead lines.

Illumination layer 1310 may include a second encapsulation layer 1350. For instance, the second encapsulation layer 1350 may be disposed on a front surface of the substrate 1312, e.g., on the face opposite the encapsulation layer 1330. In some embodiments, the second encapsulation layer 1350 may have a radius of curvature. For instance, the radius of curvature may be selected to provide a refractive lens power. While illumination layer 1310 is illustrated as having the second encapsulation layer 1350 disposed on the front face of the substrate 1312, a skilled artisan will understand that an encapsulation layer with a radius of curvature may be disposed on a rear surface of the substrate 1312. Due to the radius of curvature of the second encapsulation layer 1350, a separate refractive optical component may be redundant. For example, referring to optical system 500, where optical power can be provided by inner lens 507, optical power provided by the second encapsulation layer 1350 may make inner lens 507 redundant. Thus, embodiments that include a second encapsulation layer 1350 with a radius of curvature, may eliminate the inner lens 507 (and/or similar component that provides optical power) from the optical system 500 stack. This can reduce the total number of optical components as well as the number of optical interfaces, which can improve the optical image quality presented to a user.

As shown in the figure, the second encapsulation layer 1350 may include a second patterned surface 1352. The second patterned surface 1352 may be disposed along the radius of curvature of the second encapsulation layer 1350. The second patterned surface 1352 can reduce manufacturing time and cost associated with applying an additional anti-reflection coating onto a curved surface. In some embodiments, the second patterned surface 1352 may include the same pattern as first patterned surface 1332. In some embodiments, the second patterned surface 1352 may include a different pattern from the first patterned surface 1332. A skilled artisan will understand that the specific pattern of the first and second patterned surfaces are not intended to limit the scope of this disclosure.

Accordingly, encapsulation layers 1330, 1350 can improve transmittance and reduced haze of illumination layer 1310. Moreover, the encapsulation layers 1330, 1350 may improve the mechanical stability of the illumination layer 1310, by providing additional rigidity to the substrate 1312. Further, the first encapsulation layer 1330 can embed and passivate the one or more LEDs 1314 and/or lead lines. Finally, the second encapsulation layer 1350 can reduce the size of the optical system, e.g., optical system 500, by eliminating the need to include a separate optical component that provides optical power.

FIG. 14 illustrates an exemplary illumination layer 1410 for an example MR system according to embodiments of this disclosure. As shown in the figure, the illumination layer 1410 can include a substrate 1412, one or more LEDs 1414, a first encapsulation layer 1430, and a second encapsulation layer 1450. In comparison to illumination layer 1310, the one or more LEDs 1414 may be mounted on a front surface of the substrate 1412. As shown, the one or more LEDs 1414 may be configured to project light 1416 away from the substrate 1412 and toward an eye of a user (not shown). Accordingly, illumination layer 1410 may be characterized as a front-lit illumination layer.

As shown in the figure, the first encapsulation layer 1430 may be disposed on a rear surface of the illumination layer 1410. In some embodiments, the first encapsulation layer 1430 can include a patterned surface 1432. For example, as shown in the figure, the first patterned surface 1432 may be located on the rear surface of the encapsulation layer 1430 and/or illumination layer 1410. As discussed above, the patterned surface 1432 of the encapsulation layer 1430 may planarize and reduce loss of transmission associated with surface imperfections and undulations of the substrate 1412, e.g., the polymer layer 1434 of the substrate 1412. For example, the encapsulation layer 1430 may include a patterned surface 1432 that can reduce visible light reflections, e.g., reduce haze and improve transmittance.

In some embodiments, the illumination layer 1410 can include a second encapsulation layer 1450 disposed on a front surface of the substrate 1412. Because the illumination layer 1410 includes one or more LEDs 1414 mounted on a front face of the substrate 1412, the second encapsulation layer 1450 can be disposed over the one or more LEDs 1414, i.e., the one or more LEDs 1414 and/or lead lines (not shown) are covered by the encapsulation layer 1130. In some embodiments, the illumination layer 1410 can include one or more leads (not shown).

In some embodiments, the second encapsulation layer 1450 may have a radius of curvature. As discussed above with respect to illumination layer 1410, the radius of curvature may be selected to provide a refractive lens power. Thus, in embodiments that include a second encapsulation layer 1450 with a radius of curvature, the inner lens 507 can be eliminated from the optical system 500 stack, which can reduce the total number of optical components as well as the number of optical interfaces of the optical system. Further, in one or more examples, the radius of curvature of the second encapsulation layer 1452 can be associated with a height of about 200-300 micron. Thus, when the second encapsulation layer 1452 having a radius of curvature is disposed over the one or more LEDs 1414, the illumination layer 1410 may be thinner than the embodiments, where a substantially planar encapsulation layer is used to cover the one or more LEDs, e.g., illumination layer 1310. This may be seen by comparing the thicknesses of the illumination layer 1310 and illumination layer 1410.

Accordingly, encapsulation layers 1430, 1450 can improve transmittance and reduced haze of illumination layer 1310. Moreover, the encapsulation layers 1430, 1450 may improve the mechanical stability of the illumination layer 1410, by providing additional rigidity to the substrate 1412. Further, the first encapsulation layer 1430 can embed and passivate the one or more LEDs 1414 and/or lead lines. Finally, the second encapsulation layer 1450 can reduce the size of the optical system, e.g., optical system 500, by eliminating the need to include a separate optical component that provides optical power.

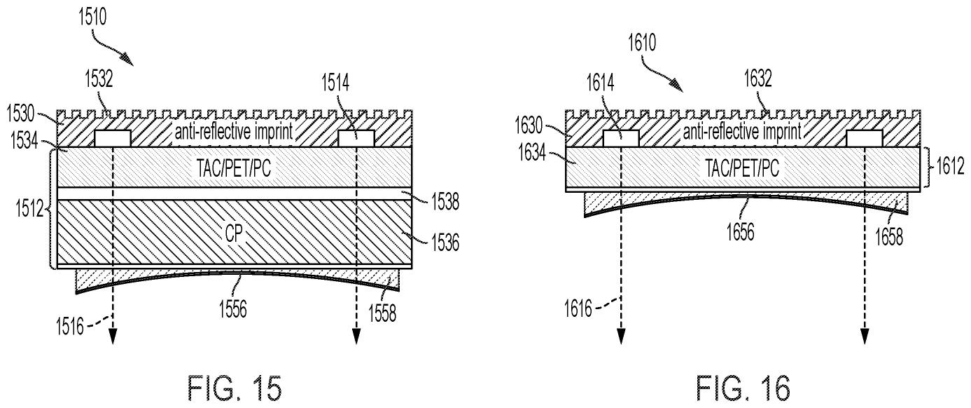

FIG. 15 illustrates an exemplary illumination layer 1510 for an example MR system according to embodiments of this disclosure. As shown in the figure, the illumination layer 1510 can include a substrate 1512, one or more LEDs 1514, a first encapsulation layer 1530, and a refractive lens 1558. As shown in the figure, the illumination layer 1510 may be a backlit illumination layer. In one or more embodiments, the encapsulation layer 1530 may be similar to, for example, encapsulation layers 1130 and 1230.

As shown in the figure, the substrate 1512 of the illumination layer 1510 may include a polymer layer 1534 disposed on a carrier plate 1536. The polymer layer 1534 may be formed from, for example, PET, PC, and TAC. In some embodiments, the carrier plate 1136 may be formed from a glass plate. In some embodiments, an index-matching layer 1538 may be located between the polymer layer 1534 and the carrier plate 1536. In some embodiments, the illumination layer 1510 can include refractive lens 1558 disposed on a front surface of the substrate 1512, e.g., opposite the encapsulation layer 1530. In some embodiments, the refractive lens 1558 may be coated with an anti-reflective surface 1556.

In some embodiments, a second index-matching layer 1542 may be disposed between the carrier plate 1536 and the refractive lens 1558. Because the illumination layer may include a refractive lens mounted to a front surface of the substrate 1512, a separate refractive optical component may be redundant. For example, referring to optical system 500, where optical power can be provided by inner lens 507, optical power provided by the second encapsulation layer 1550 may make inner lens 507.

Accordingly, encapsulation layer 1530 may improve transmittance and reduced haze of illumination layer 1510. Moreover, the encapsulation layer 1530 may improve the mechanical stability of the substrate 1512, by improving the rigidity of 1510. Further, the encapsulation layer 1530 can embed and passivate the one or more LEDs 1514 and/or lead lines. Finally, the refractive lens 1558 can reduce the size of the optical system, e.g., optical system 500, by eliminating the need to include a separate optical component that provides optical power.

FIG. 16 illustrates an exemplary illumination layer 1610 for an example MR system according to embodiments of this disclosure. As shown in the figure, the illumination layer 1610 can include a substrate 1612, one or more LEDs 1614, a first encapsulation layer 1630, and a refractive lens 1658. In some embodiments, the substrate 1612 can be formed from a polymer layer 1634. For example, unlike illumination layer 1610, illumination 1510 need not include a carrier plate, e.g., carrier plate 1536.

In some embodiments, features of the illumination layer 1610 (e.g., apart from substrate 1612) may be analogous to illumination layer 1510. For example, as shown in the figure, the encapsulation layer 1630 may be disposed on a rear surface of the substrate 1612, such that the encapsulation layer 1630 is disposed over the one or more LEDs 1614, i.e., the one or more LEDs 1614 are covered by the encapsulation layer 1630. The encapsulation layer 1630 may include a rear-patterned surface 1632. The patterned surface 1632 may be similar to the patterned surfaces described above. In some embodiments, the illumination layer 1610 can include one or more leads (not shown). In some embodiments, the illumination layer 1610 can include an anti-reflective coating 1640 disposed on a front surface of the substrate, e.g., opposite the encapsulation layer 6230. Accordingly, illumination layer 1610 may provide improved transmittance and reduced haze compared to, for example, illumination layer 610A, 610B. Moreover, the encapsulation layer 1630 of illumination layer 1610 may improve the mechanical stability of the substrate 1612, with the addition of additional material, e.g., encapsulation layer 1630. Further, the encapsulation layer 1630 of illumination layer 1610 can embed and passivate the one or more LEDs 1614 and/or lead lines. Further, the refractive lens 1658 can reduce the size of the optical system, e.g., optical system 500, by eliminating the need to include a separate optical component to provide optical power.

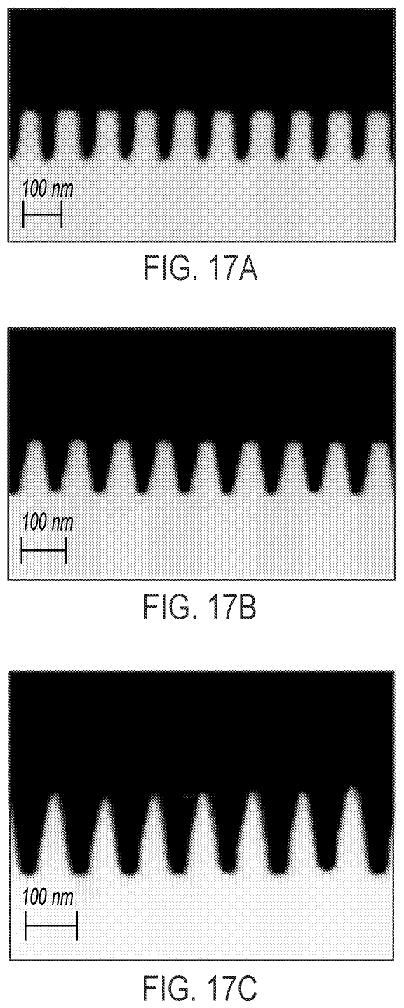

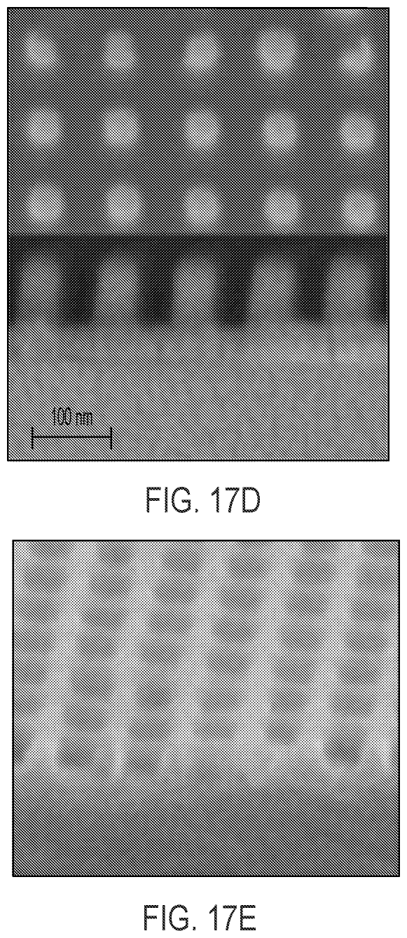

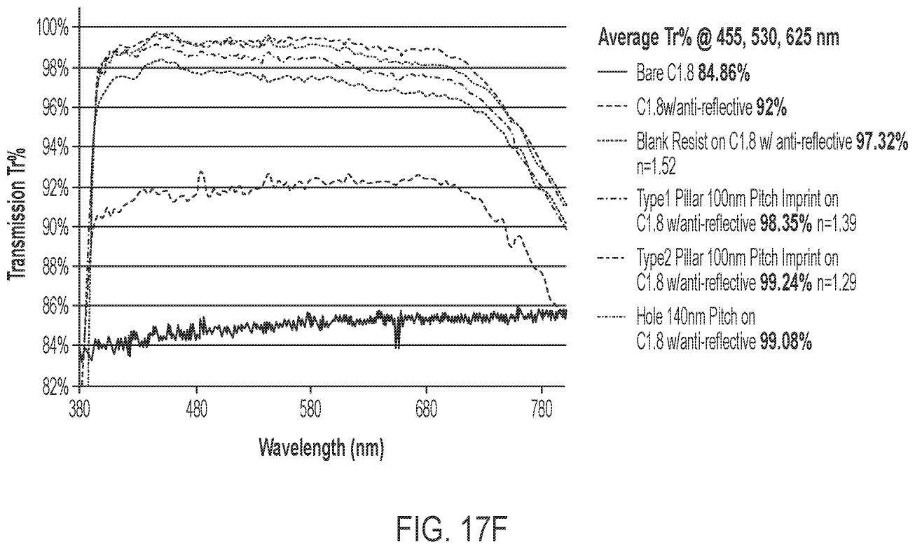

FIGS. 17A-17C illustrate example patterns for an encapsulation layer, such as described above, according to embodiments of this disclosure. In some embodiments, the patterns may include at least one selected from lines and spaces, pillars, and holes. FIGS. 17A-C illustrate a cross-sectional view of exemplary lines and spaces patterns. In some embodiments, the pitch of the lines and spaces pattern can be about 100-150 nm. As shown in the figures, the lines may have different geometries. For instance, as shown in FIG. 17A, an example lines and spaces pattern can include lines having an approximately rectangular cross-section. FIG. 17B illustrates an exemplary lines and spaces pattern having a relatively, e.g., compared to 1700A, tapered geometry having a truncated triangle cross-section. FIG. 17C illustrates an exemplary lines and spaces pattern having a relatively, e.g., compared to 1700A and 1700B, tapered having a triangular cross-section.

FIG. 17D illustrates an exemplary pillars pattern. In some embodiments, the pitch of the pillars pattern can be about 100-150 nm. As shown in the figures, the pillars can have a cylindrical geometry, although other geometries may be used without departing from the scope of this disclosure. In some embodiments, the pillars can have a diameter of about 10-140 nm. FIG. 17E illustrates an exemplary holes pattern. In some embodiments, the pitch of the holes pattern can be about 100-150 nm.

FIG. 17F is a graph that illustrates the exemplary transmittance of various patterns types, including an illumination layer without a patterned surface or other anti-reflective coating 1701, an illumination layer with an anti-reflective surface 1703, an illumination layer with an encapsulation layer without a patterned surface 1705, an illumination layer having an encapsulation layer with a pillar-type patterned surface 1707, an illumination layer having an encapsulation layer with a second pillar-type patterned surface 1709, and an illumination layer having an encapsulation layer with a hole-type patterned surface 1711. As shown in the figure, the illumination layers with a patterned surface may have about a 5-7% improvement in transmittance of visible light.

### Manufacturing an Encapsulation Layer for Illumination Layer

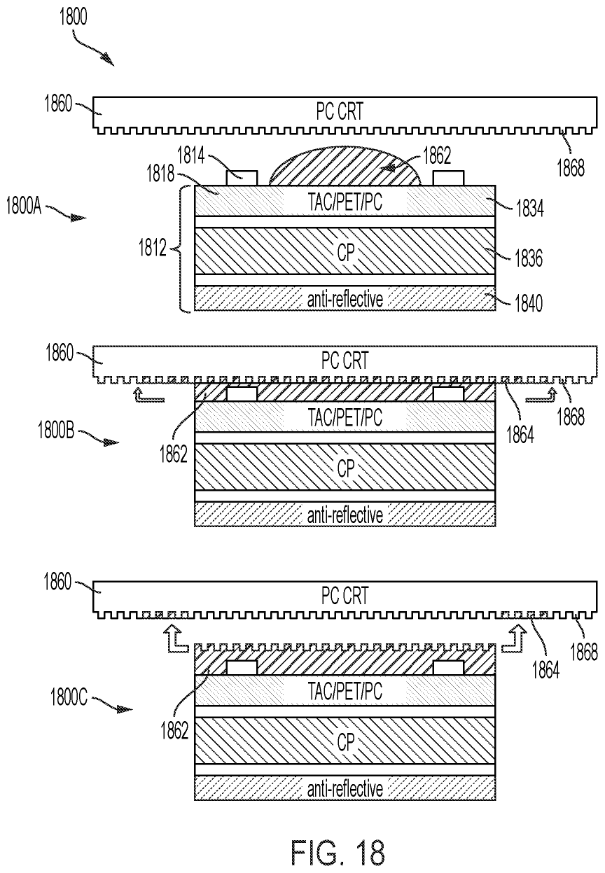

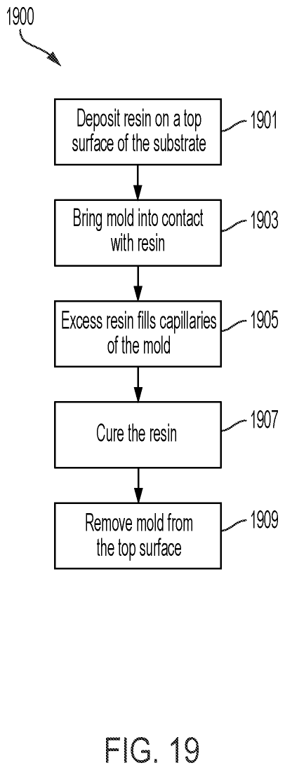

FIG. 18 illustrates a process 1800 for manufacturing an exemplary illumination layer for an example MR system according to embodiments of the present disclosure. As shown in the figure, an illumination layer, e.g., illumination layers such as 1100, 1200, 1300, 1400, 1500, and 1600 described above can be manufactured using jet and flash imprint lithography (J-FIL) processes. The following description of process 1800 will also be described with reference to FIG. 19, which is a flow diagram 1900 that illustrates an exemplary process for manufacturing an example illumination layer for an MR system according to embodiments of the present disclosure. For example, the flow diagram 1900 can describe the steps illustrated in process 1800.

In one or more examples of the disclosure, the process 1800 depicted in FIG. 18 can begin at step 1901, wherein resin 1862 can be deposited on a top surface 1818 of the substrate 1812. In some embodiments, the resin 1862 can be a ultra-violet light curable resin. In some embodiments, the resin 1862 can be deposited by a printer-head onto the top surface 1818 of the substrate 1812. In some embodiments, the resin can be deposited as a single drop. In some embodiments, the resin 1862 can be deposited as a plurality of drops, wherein each drop is separately deposited.

In one or more examples, after the resin 1862 has been deposited, the mold 1860 may be moved into contact with resin 1862 (step 1903). The resin 1862 may conform to the shape of the mold 1860 once the mold 1860 is moved into contact with the resin 1862, as illustrated in 1800B. In some embodiments, the mold can be a coded resist template (CRT). In some embodiments, the coded resist template may include a plurality of nano-features 1868. The plurality of nano-features may be configured to impart a nano-pattern to produce a patterned surface on the encapsulation layer, e.g., patterned surface 832 and 1132-1632. The patterned surface may correspond to the various patterns discussed with respect to FIGS. 17A-17xx. A skilled artisan will understand that the scope of the disclosure is not intended to be limited by the patterns illustrated in FIGS. 17A-17xx.

In one or more examples, as shown in 1800B, excess resin 1864 may fill the nano-features 1868 of the mold (step 1905). For instance, the nano-features 1868 may encourage capillary action that enables excess resin 1864 to flow into the narrow spaces between the nano-features 1868. In this manner, illumination layers manufactured in accordance with embodiments of the present disclosure may have clean edges, i.e., because excess resin 1864 may not flow down a side of the illumination layer. This may enable illumination layers to be cut to size before depositing the encapsulation layer. In some embodiments one or more illumination layers may be cut to size after depositing the encapsulation layer.

In one or more examples, the resin 1860 can be cured (step 1907), once the mold 1860 has been moved into contact with resin 1862 (step 1903). In some embodiments, the resin can be cured by exposing the resin to UV light. In one or more examples, the resin can be exposed to heat and/or a combination of heat and UV light. For example, the resin can be pre-heated, e.g., exposed to heat prior to exposure to UV light. In such examples, the heat exposure can improve the crosslinking density of the resin. In some examples, the resin can be exposed to heat after being exposed to UV light with or without pre-heating. In one or more examples, the mold 1860 has can be removed from the illumination layer (step 1909). In some embodiments, the mold 1860 may be removed after the resin has cured. In some embodiments, the excess resin 1864 may be removed with the mold 1860. In some embodiments, the excess resin 1864 can be deposited onto a sacrificial surface, so that the mold 1860 may be re-used. In some embodiments, the excess resin may evaporate from the mold once the mold 1860 is removed.

Although the process 1800 shows a substantially planar mold 1860, in some embodiments the mold 1860 may include a soft and/or curved mold. For example, the mold may be a soft mold as described in Nanoimprint Lithography Methods on Curved Substrates, which is hereby incorporated by reference in its entirety. The curved mold as described in Nanoimprint Lithography Methods on Curved Substrate may enable a skilled artisan to form an encapsulation layer, e.g., encapsulation layers 1550, 1650, with a finite radius of curvature, as described above with respect to FIGS. 18 and 19.

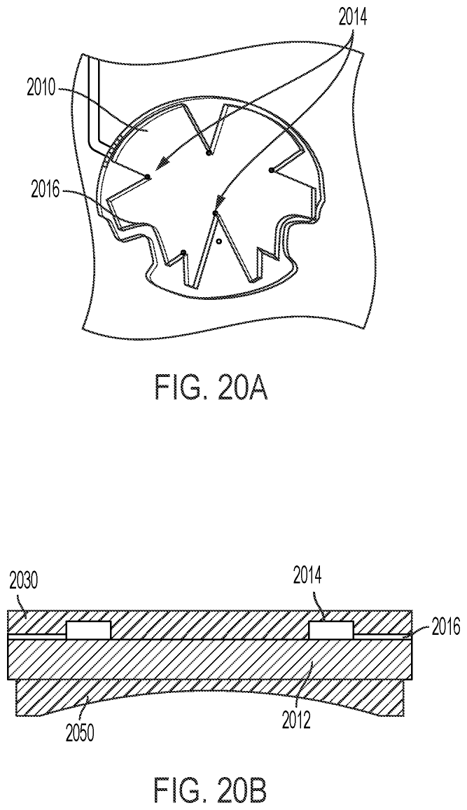

FIGS. 20A-20B illustrate an illumination layer 2010 manufactured in accordance with processes 1800 and 1900. FIG. 20A illustrates a top view of the illumination layer 2010, which may be a substantially transparent component with improved transmittance in accordance with the above disclosure. In some embodiments, the illumination layer 2010 can include one or more LEDs 2014 and one or more metal traces 2016. FIG. 20B illustrates an exemplary cross-sectional view of illumination layer 2010. As shown in the figure, the illumination layer 2010 may be similar to illumination layer 1310. For instance, as shown in the figure, the illumination layer 2010 can include a substrate 2012, one or more LEDs 2014, one or more lead lines 2016, a first encapsulation layer 2030, and a second encapsulation layer 2050. As shown in the figure, second encapsulation layer 2050 can have optical power.

Accordingly, the illumination layer 2010 manufactured in accordance with embodiments of this disclosure may provide improved transmittance and reduced haze. Moreover, the encapsulation layers 2030, 2050 may improve the mechanical stability of the illumination layer 2010 by providing additional rigidity to the substrate 2012. Further, the first encapsulation layer 2030 can embed and passivate the one or more LEDs 2014 and/or lead lines 2016. Finally, the second encapsulation layer 2050 can provide an illumination layer having optical power.

Embodiments in accordance with this disclosure can provide a display including an infrared illumination layer, the infrared illumination layer including a substrate, one or more LEDs disposed on a first surface of the substrate, and a first encapsulation layer disposed on the first surface of the substrate, where the first encapsulation layer can include a nano-patterned surface. In some examples, the nano-patterned surface can be configured to improve a visible light transmittance of the illumination layer.

In some examples, the one or more LEDs can be covered by the first encapsulation layer. In some examples, the first encapsulation layer can have a finite radius of curvature. In some examples, the radius of curvature can be configured to increase an optical power of the illumination layer. In some examples, the first encapsulation layer can be substantially planar. In some examples, the display can include a second encapsulation layer, where the second encapsulation layer can have a second geometry different from a first geometry of the first encapsulation layer. In some examples, the substrate can include a carrier plate and a polymer layer disposed on a first surface of the carrier plate. In some examples, the nano-patterned surface can include at least one nano-pattern selected from a lines and spaces pattern, a pillars pattern, and a holes pattern. In some examples, the selected nano-pattern can have a pitch in a range of about 100-150 nm.

Embodiments in accordance with this disclosure can provide a display including an illumination layer. In one or more examples, the illumination layer can include a substrate, one or more LEDs disposed on a first surface of the substrate, and a first encapsulation layer disposed on the first surface of the substrate, where the first encapsulation layer includes a patterned surface such that the patterned surface can be configured to improve visible light transmittance of the illumination layer. In some examples, the illumination layer further comprises a second encapsulation layer, wherein the second encapsulation layer has a second geometry different from a first geometry of the first encapsulation layer. In some examples, the display can include an eyepiece, the eyepiece configured to present digital content. In some examples, the first encapsulation layer has a finite radius of curvature. In some examples, the radius of curvature can be configured to increase an optical power of the eyepiece. In some examples, the one or more LEDs can be covered by the first encapsulation layer. In some examples, the display can include a light sensor, where the light sensor can be configured to detect light reflected off an eye of a user, wherein the light can be emitted by the one or more LEDs.

Embodiments in accordance with this disclosure can provide a method including depositing resin on a first surface of a substrate, where the substrate can include an outer perimeter having one or more edges. The method can include bringing a first surface of a mold into contact with the resin. The method can include forming, with a first volume of resin, an encapsulation layer having a patterned surface on the first surface of the substrate. The method can include directing a second volume of resin into the outer perimeter of the first substrate, where at least one nano-feature of the plurality of nano-features can be located on the second portion. The method can include filling the at least one nano-feature located on the second portion of the first surface of the mold with the second volume of resin. The method can include curing the resin to bond the encapsulation layer to the substrate. The method can include removing the mold from the substrate, wherein the second volume of resin is removed along with the mold. In some examples, the first surface of the mold can be configured to include a plurality of nano-features. In some examples, the first surface of the mold can include a first portion configured to overlap with the substrate, and a second portion configured to extend beyond the outer perimeter of the substrate. In some examples, the mold can comprise a soft mold, where the first surface of the mold can have a finite radius of curvature, and the encapsulation layer can be formed with the radius of curvature such that the encapsulation layer can have an optical power. In some examples, the substrates can include one or more LEDs disposed on the first surface and the encapsulation layer can cover the one or more LEDs.

In some examples, the method can further include depositing resin on a second surface of the substrate. In some examples, the method can further include bringing the first surface of the mold into contact with the second resin. In some examples, the method can further include forming, with a third volume of resin, a second encapsulation layer having a second patterned surface on the second surface of the substrate. In some examples, the method can further include directing a fourth volume of resin into the outer perimeter of the substrate. In some examples, the method can further include filling the at least one nano-feature located on the second portion of the first surface of the mold with the fourth volume of resin. In some examples, the method can further include curing the second resin to bond the second encapsulation layer to the substrate. In some examples, the method can further include removing the mold from the substrate, wherein the fourth volume of resin is removed along with the mold.

Although the disclosed examples have been fully described with reference to the accompanying drawings, it is to be noted that various changes and modifications will become apparent to those skilled in the art. For example, elements and/or components illustrated in the drawings may be not be to scale and/or may be emphasized for explanatory purposes. As another example, elements of one or more implementations may be combined, deleted, modified, or supplemented to form further implementations. Other combinations and modifications are to be understood as being included within the scope of the disclosed examples as defined by the appended claims.

1. A display comprising an infrared illumination layer, the infrared illumination layer comprising:
a substrate;
one or more LEDs disposed on a first surface of the substrate; and
a first encapsulation layer disposed on the first surface of the substrate, wherein the first encapsulation layer comprises a nano-patterned surface configured to improve a visible light transmittance of the illumination layer.

2. The display of claim 1, wherein the one or more LEDs is covered by the first encapsulation layer.

3. The display of claim 1, wherein the first encapsulation layer has a finite radius of curvature.

4. The display of claim 3, wherein a radius of curvature of the first encapsulation layer is configured to increase an optical power of the illumination layer.

5. The display of claim 1, wherein the first encapsulation layer is substantially planar.

6. The display of claim 1, further comprising a second encapsulation layer disposed on a second surface of the substrate, wherein the second encapsulation layer has a second geometry different from a first geometry of the first encapsulation layer.

7. The display of claim 1, wherein the substrate comprises a carrier plate and further comprises a polymer layer disposed on a first surface of the carrier plate.

8. The display of claim 1, wherein the nano-patterned surface comprises at least one nano-pattern selected from a lines and spaces pattern, a pillars pattern, and a holes pattern.

9. The display of claim 8, wherein the nano-pattern has a pitch in a range of 100-150 nm.

10. A display comprising:
an illumination layer comprising:
a substrate;
one or more LEDs disposed on a first surface of the substrate; and
a first encapsulation layer disposed on the first surface of the substrate, wherein
the first encapsulation layer comprises a patterned surface such that the patterned surface is configured to improve visible light transmittance of the illumination layer.

11. The display of claim 10, wherein the illumination layer further comprises a second encapsulation layer on a second surface of the substrate, wherein the second encapsulation layer has a second geometry different from a first geometry of the first encapsulation layer.

12. The display of claim 10, further comprising an eyepiece, the eyepiece configured to present digital content.

13. The display of claim 12, wherein the first encapsulation layer has a finite radius of curvature.

14. The display of claim 13, wherein the radius of curvature is configured to increase an optical power of the eyepiece.

15. The display of claim 10, wherein the one or more LEDs is covered by the first encapsulation layer.

16. The display of claim 10, further comprising a light sensor, the light sensor configured to detect light reflected off an eye of a user, wherein the light is emitted by the one or more LEDs.

17. A method comprising:
depositing resin on a first surface of a substrate, wherein the substrate includes an outer perimeter having one or more edges;
bringing a first surface of a mold into contact with the resin;
forming, with a first volume of resin, an encapsulation layer having a patterned surface on the first surface of the substrate; and
directing a second volume of resin into the outer perimeter of the substrate;
wherein the first surface of the mold is configured to include a plurality of nano-features, and
wherein the first surface of the mold comprises:
a first portion configured to overlap with the substrate, and
a second portion configured to extend beyond the outer perimeter of the substrate, at least one nano-feature of the plurality of nano-features located on the second portion;
filling the at least one nano-feature located on the second portion of the first surface of the mold with the second volume of resin;
curing the resin to bond the encapsulation layer to the substrate; and
removing the mold from the substrate, wherein the second volume of resin is removed along with the mold.

18. The method of claim 17, wherein the mold comprises a soft mold, the first surface of the mold has a finite radius of curvature, and the encapsulation layer is formed with the radius of curvature such that the encapsulation layer has an optical power.

19. The method of claim 17, wherein the substrate comprises one or more LEDs disposed on the first surface, and wherein the encapsulation layer covers the one or more LEDs.

20. The method of claim 17, further comprising:
depositing a second resin on a second surface of the substrate;
bringing the first surface of the mold into contact with the second resin;
forming, with a third volume of resin, a second encapsulation layer having a second patterned surface on the second surface of the substrate; and
directing a fourth volume of resin into the outer perimeter of the substrate;
filling the at least one nano-feature located on the second portion of the first surface of the mold with the fourth volume of resin;
curing the second resin to bond the second encapsulation layer to the substrate; and
removing the mold from the substrate, wherein the fourth volume of resin is removed along with the mold.
